(19) United States
(12) Patent Application Publication
(10) Pub. No.: US 2021/0402751 A1
(43) Pub. Date: Dec. 30, 2021

(54) TOOLS HAVING ONE OR MORE PLATES FOR USE IN FORMING LAMINATES USING PRESSES AND RELATED METHODS

(71) Applicant: SABIC Global Technologies B.V., Bergen op Zoom (NL)

(72) Inventors: Theofanis THEOFANOUS, Elsloo (NL); Roel VERLAEK, Elsloo (NL); Guillaume RATOUIT, Elsloo (NL); Recep YALDIZ, Elsloo (NL)

(21) Appl. No.: 16/494,914

(22) PCT Filed: Jan. 31, 2018
(86) PCT No.: PCT/IB2018/050611

§ 371 Date: Sep. 17, 2019

Related U.S. Application Data
(60) Provisional application No. 62/473,302, filed on Mar. 17, 2017.
(60) Provisional application No. 62/473,304, filed on Mar. 17, 2017.
(60) Provisional application No. 62/624,077, filed on Jan. 30, 2018.

(51) Int. Cl. B32B 37/10; B29C 31/08; B29C 70/46; B29C 70/54; B29C 33/68; B29C 37/00

(52) U.S. Cl. CPC B32B 37/10; B29C 31/08; B29C 37/0067; B29C 70/54; B29C 33/68; B29C 70/46

(57) ABSTRACT

A system for pressing one or more stacks of one or more laminae (22), the system comprising: a tool including top (14b) and bottom plates (14a) configured to be disposed on opposing sides of each of one or more stacks (22) of one or more laminae, each of the plates (14a, 14b) having: a center region that overlies or underlies the stack(s) (22) when the stack(s) are disposed between the plates (14a, 14b); and tabs (174) that extend outwardly from edges of the center region and are configured to be coupled to a conveyor or one or more grippers for moving the plate; and a resilient layer (90) configured to be disposed between the top plate and the stack(s) (22) or the bottom plate (14a) and the stack(s) (22); wherein the resilient layer (90) is sized to be disposable between the plates such that, for each of the plates (14a, 14b): the resilient layer (90) overlies or underlies at least 90% of the center region; one or more portions of the resilient layer (90) neither overlie nor underlie the plate; and at least a portion of each of the tabs neither overlies nor underlies the resilient layer ((14a, 14b)). Also claimed is a method for producing laminates by pressing.

### CROSS-REFERENCE TO RELATED APPLICATIONS

This application claims the benefit of priority of U.S. Provisional Patent Application No. 62/473,302 filed Mar. 17, 2017, U.S. Provisional Patent Application No. 62/473,304 filed Mar. 17, 2017, and U.S. Provisional Patent Application No. 62/624,077 filed Jan. 30, 2018. The entire contents of each of the above-referenced disclosures are specifically incorporated herein by reference without disclaimer.

### FIELD OF INVENTION

The present invention relates generally to composite laminates, and more specifically, to tools having one or more plates for use in forming laminates using presses; such tools may be particularly suited for use in forming thin laminates (e.g., having a thickness of less than 2 millimeters (mm)); and additionally, to systems and methods for forming laminates using multiple sets of pressing elements.

### DESCRIPTION OF RELATED ART

Composite laminates can be used to form structures having advantageous structural characteristics, such as high stiffnesses and high strengths, as well as relatively low weights, when compared to structures formed from conventional materials. As a result, composite laminates are used in a wide variety of applications across a wide range of industries, including the automotive, aerospace, and consumer electronics industries.

To produce such a laminate, a stack of one or more laminae can be consolidated by compressing the stack between heated pressing elements. Producing a laminate in this way is not without challenges. For example, when the stack is pressed, uneven pressing surfaces of the pressing elements, uneven distributions of material (e.g., fibers and matrix material) within the lamina(e), and/or the like can result in an uneven distribution of pressure between the stack and the pressing elements, which may be exacerbated when the stack is thin. Such an uneven distribution of pressure can result in uneven distributions of material (e.g., fibers and matrix material), unpredictable structural characteristics, an uneven surface finish, and/or the like in the produced laminate.

### SUMMARY

Some embodiments of the present tools are configured to encourage an even application of pressure between pressing elements of a press and a stack of one or more laminae, transportation of the stack to and from the press, and/or the like by, for example, including one or more plates, each disposable between the stack and one of the pressing elements. Some tools include a resilient layer that is disposable between the stack and one of the plate(s); such a resilient layer can, in addition to enhancing the preceding functionality, resist separation of the stack and the plate when another one of the plate(s) (if present) is removed from the stack, allow transportation of the stack via transportation of the resilient layer (free from any plate(s)), and/or the like.

A composite laminate can be produced by pre-heating a stack of one or more laminae, consolidating the stack, and cooling the stack. For each of these steps, the stack temperature required to achieve desirable results may differ. Some of the present methods, at least by using respective sets of pressing elements for performing at least two of the pre-heating step, the consolidating step, and the cooling step, can reduce the need to vary a temperature of at least one of the sets of pressing elements, thereby reducing the energy and time involved in producing the laminate.

Similarly, the time required to perform these steps may differ. To illustrate, the pre-heating step may require approximately 40 seconds for effective pre-heating, while the consolidating and cooling steps may require approximately 10 seconds for effective consolidation and cooling. Some of the present methods can provide for increased throughput at least by using multiple sets of pressing elements for at least one of the pre-heating step, the consolidating step, and the cooling step (e.g., for the step that requires the longest amount of time).

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/have/include/contain—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts a first embodiment of the present tools for use in pressing a stack of one or more laminae, shown disposed between pressing elements of a press.

FIGS. 2A and 2B are top and bottom views, respectively, of a plate of the tool of FIG. 1.

FIG. 2C is a cross-sectional side view of the plate of FIGS. 2A and 2B, taken along line 2C-2C of FIG. 2A.

FIG. 3 is a top view of a resilient layer that may be suitable for use in some embodiments of the present tools.

FIGS. 4A-4D are cross-sectional side views of plates, each of which may be suitable for use in some embodiments of the present tools.

FIG. 5 is a cross-sectional side view of the tool of FIG. 1, shown coupled to a stack of one or more laminae.

FIGS. 6A and 6B are drawn-to-scale bottom and top views, respectively, of a plate that may be suitable for use in some embodiments of the present tools.

FIG. 6C is an enlarged, drawn-to-scale view of one of the tabs of the plate of FIGS. 6A and 6B.

FIG. 7 is a drawn-to-scale top view of a plate that may be suitable for use in some embodiments of the present tools.

FIG. 8A is a drawn-to-scale top view of a plate that may be suitable for use in some embodiments of the present tools.

FIG. 8B is an enlarged, drawn-to-scale view of one of the tabs of the plate of FIG. 8A.

FIG. 9A is a drawn-to-scale top view of the plate of FIGS. 6A-6C with a resilient layer disposed thereon.

FIG. 9B is a top view of the plate and the resilient layer of FIG. 9A with a stack of one or more laminate disposed on the resilient layer.

FIG. 9C is a cross-sectional side view of the plate, resilient layer, and stack of FIG. 9B (taken along line 9C-9C of FIG. 9B), with another plate positioned such that the stack is disposed between the plates.

FIG. 10 shows the plate of FIGS. 6A-6C positioned on a pressing surface of a press.

FIG. 11 is an exploded view of a stack of one or more laminae that may be pressed using some embodiments of the present tools.

FIG. 12 depicts a lamina that may be included in a stack of one or more laminae.

FIGS. 13A and 13B are top and side views, respectively, of a third embodiment of the present tools including tabs that facilitate coupling plates of the tool together.

FIGS. 14A and 14B depict a fourth embodiment of the present tools including tabs that facilitate coupling plates of the tool together.

FIG. 15 is a cross-sectional side view of a tab that may be included in some embodiments of the present tools.

FIGS. 16A and 16B depict a method for handling some embodiments of the present tools.

FIG. 17 is a cross-sectional side view of a fifth embodiment of the present tools, which includes protrusion(s) and recess(es) for coupling plates of the tool together.

FIG. 18 is a cross-sectional side view of a sixth embodiment of the present tools, which is for forming a laminate having non-planar portions.

FIG. 19 is a top view of a plate that may be suitable for use in some of the present tools, the plate including openings for mitigating distortion of the plate due to thermal expansion.

FIG. 20 depicts one method for pressing two or more stacks of one or more laminae using an embodiment of the present tools.

FIG. 21 depicts embodiments of the present methods for forming a laminate by pre-heating a stack of one or more laminae, consolidating the stack using a first set of pressing elements, and cooling the stack using a second set of pressing elements.

FIG. 22 depicts a first embodiment of the present systems for forming a laminate, which may be used to implement some methods of FIG. 21.

FIG. 23 is a cross-sectional side view of a set of pressing elements that may be suitable for use in some embodiments of the present methods and/or systems.

FIG. 24 is a side view of a conveyor that may be suitable for use in some embodiments of the present methods and/or systems for conveying a stack of one or more laminae (e.g., between sets of pressing elements).

FIG. 25 is a cross-sectional side view of a belt that may be suitable for use in some embodiments of the present methods and/or systems for conveying a stack of one or more laminae (e.g., between sets of pressing elements), the belt including a layer, at least a portion of which is configured to become part of a laminate formed during consolidation of the stack.

FIG. 26 depicts a second embodiment of the present systems for forming a laminate, which may be used to implement some methods of FIG. 21.

FIGS. 27A-27E illustrate embodiments of the present methods for producing one or more laminates, including: (1) disposing one or more stacks of one or more laminae between top and bottom plates of a tool and on resilient layer that is disposed between the stack(s) and the bottom plate; (2) consolidating the stack(s) at least by pressing the plates with a press (FIG. 27A); removing the top plate from the laminate(s) without removing the laminate(s) from the resilient layer or the resilient layer from the bottom plate (FIG. 27C); and (3) removing the resilient layer from the bottom plate without removing the laminate(s) from the resilient layer (FIG. 27D).

FIG. 28 is a graph of stack temperature vs. time during production of a laminate using an embodiment of the present methods.

FIG. 29 illustrates boundary conditions for simulations of heating of a plate when the plate is used to form a laminate.

FIGS. 30A-32C each show steady state temperature of a plate when used to form a laminate, where each figure number—30, 31, and 32—corresponds to a respective set of conditions, and each figure letter corresponds to a respective plate: A corresponds to a “flat plate;” B corresponds to the plate of FIGS. 6A-6C; and C corresponds to a plate having bent edges (a “bent plate”).

FIGS. 33A-35C show steady state stresses for the plates and conditions of FIGS. 30A-32C, respectively.

FIGS. 36A-36C show steady state temperatures of the plate of FIGS. 6A-6C, the plate of FIG. 7, and the plate of FIGS. 8A and 8B, respectively, when used under the same conditions to form a laminate.

FIGS. 37A-37C show steady state stresses for the plates and conditions of FIGS. 36A-36C, respectively.

FIGS. 38A-38D show steady state displacements (total and in the x-, z-, and y-directions, respectively) for a plate when used to form a laminate.

FIGS. 39A and 39B show a plate in an undisplaced state (FIG. 39A) and a (exaggerated) displaced state (FIG. 39B) due to heating.

FIG. 40A shows steady state temperature for a plate that is otherwise similar to that of FIG. 32A but is thicker, under the conditions of FIG. 32A.

FIG. 40B shows steady state temperature for a plate that is otherwise similar to that of FIG. 32B but comprises a different material, under the conditions of FIG. 32B.

FIG. 41A shows steady state stresses for the plate and conditions of FIG. 40A.

FIG. 41B shows steady state stresses for the plate and conditions of FIG. 40B.

FIG. 42 shows steady state temperature for the plate of FIG. 36B under conditions that are otherwise similar to those of FIG. 36B, but with a higher temperature applied to the plate.

FIG. 43A shows steady state stresses for the plate and conditions of FIG. 42.

FIG. 43B shows steady state stresses for the plate of FIG. 36C under conditions that are otherwise similar to those of FIG. 36C, but with a higher temperature applied to the plate.

FIG. 44 shows residual stresses in the plate of FIG. 43A when used under the conditions of FIG. 43A to form a laminate and then allowed to cool to room temperature.

### DETAILED DESCRIPTION

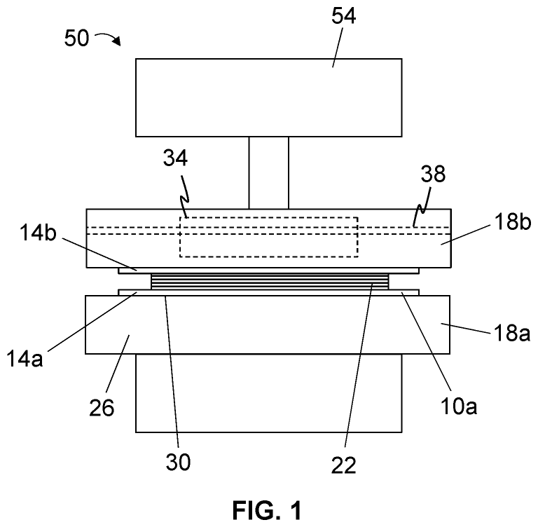

FIG. 1 depicts a first embodiment 10a of the present tools for use in pressing a stack of one or more laminae during, for example, heating, cooling, and/or consolidation of the stack. The present tools (e.g., 10a) can include one or more plates (e.g., 14a and 14b), each configured to be disposed between one of a set of pressing elements (e.g., 18a and 18b) and a stack (e.g., 22) of one or more laminae such that the plate defines an interface between the pressing element and the stack when the stack is pressed by the pressing element. As will be described below, the plate(s) can facilitate heating, consolidation, and/or cooling of the stack and/or transportation of the stack (e.g., to and from the pressing elements).

Pressing elements (e.g., 18a and 18b) each can comprise any suitable pressing element, such as, for example, a platen, plate, block, and/or the like, and can be characterized generally as having a body (e.g., 26) defining a pressing surface (e.g., 30), whether planar, concave, and/or convex, that is configured to contact an object when the object is pressed by the pressing element. At least one of the pressing elements can be configured to have a variable temperature via, for example, including one or more electric heating elements (e.g., 34), one or more interior passageways (e.g., 38) through which heating and/or cooling fluid (e.g., water, steam, a thermal fluid, and/or the like) can be passed, and/or the like.

As shown in FIG. 1, pressing elements (e.g., 18a and 18b) can be components of a press 50. To illustrate, press 50 can include one or more actuators 54, each coupled to at least one of the pressing elements, where the actuator(s) are configured to move the pressing elements relative to one another to press an object between the pressing elements. Actuator(s) 54 can include any suitable actuator, such as, for example, a hydraulic, electric, and/or pneumatic actuator.

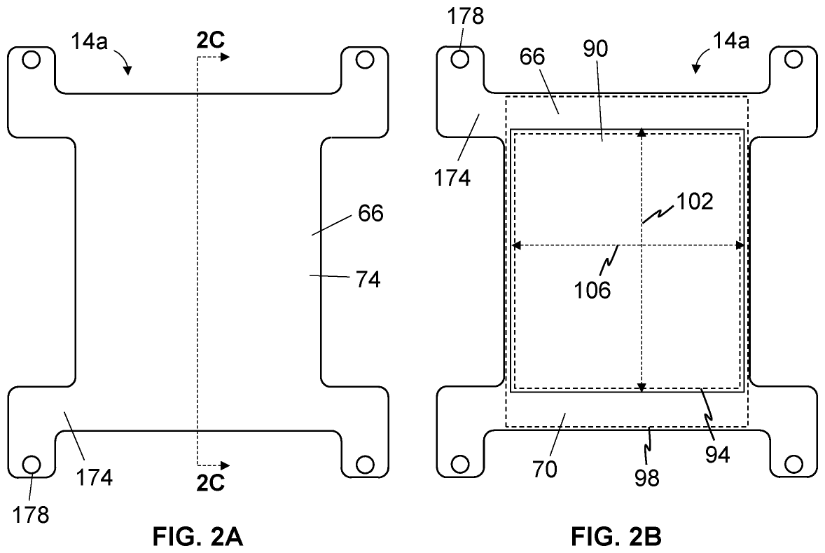

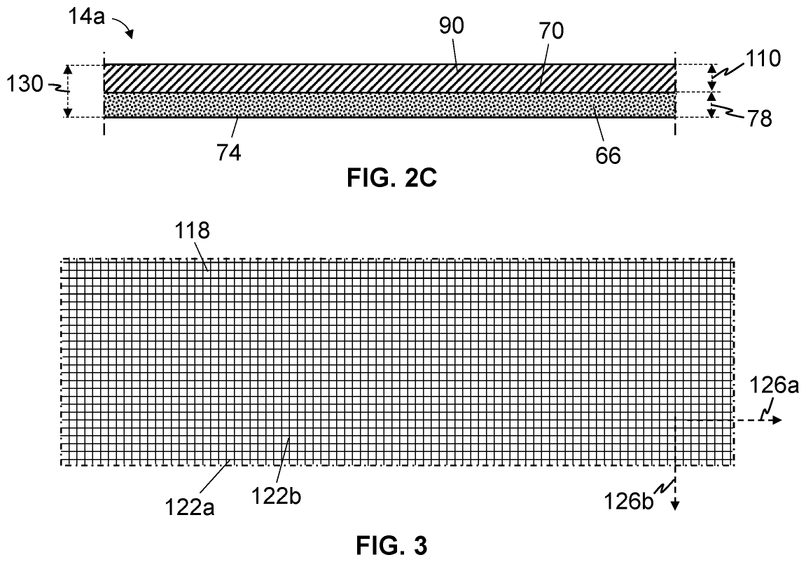

Referring now to FIGS. 2A-2C, shown is a plate 14a of tool 10a. Plate 14a can include one or more layers that aid in heating, cooling, and/or consolidation of a stack of one or more laminae (e.g., 22) using a set of pressing elements (e.g., 18a and 18b). Such layer(s) can include, for example, thermally-conductive layer(s), which facilitate transfer of heat between the pressing element(s) and the stack, and/or resilient layer(s), which encourage an even application of pressure to the stack by the pressing elements. A plate (e.g., 14a), depending on its layer(s), may or may not be rigid.

For example, plate 14a can include a metal layer 66. Metal layer 66 can have an upper surface 70, or a surface that faces a stack of one or more laminae (e.g., 22) when the stack is disposed on plate 14a, and a lower surface 74 that is opposite the upper surface. Metal layer 66 can have any suitable thickness 78, such as, for example, a thickness that is less than or substantially equal to any one of, or between any two of: 0.25, 0.30, 0.35, 0.40, 0.45, 0.50, 0.55, 0.60, 0.65, 0.70, 0.75, 0.80, 0.85, 0.90, 0.95, 1.00, 1.10, 1.20, 1.30, 1.40, 1.50, 1.60, 1.70, 1.80, 1.90, 2.00, 2.50, or 3.00 mm (e.g., approximately 0.50 mm, less than approximately 2.00 mm, and/or the like). Metal layer 66 can comprise any suitable metal, and such a metal may be thermally-conductive. For example, in plate 14a, metal layer 66 can comprise stainless steel. In other plates, a metal layer (e.g., 66) can comprise this and/or any other suitable metal, such as, for example, copper, aluminum, brass, steel, bronze, an alloy thereof, and/or the like.

A metal layer (e.g., 66) including a thermally-conductive metal can increase a plate's ability to transfer heat between a stack of one or more laminae (e.g., 22) and a pressing element (e.g., 18a or 18b), and such functionality can be enhanced by the metal layer having a relatively small thickness (e.g., 78). A metal layer (e.g., 66) can add rigidity to a plate (e.g., 14a), which can facilitate transportation of the plate (e.g., to and from pressing elements 18a and 18b), provide support for a stack of one or more laminae (e.g., 22) disposed on the plate, provide support for resilient layer(s) (e.g., 90, described below) of or disposed on the plate, and/or the like.

Plate 14a can include a resilient layer 90 coupled to metal layer 66. As used herein, a first layer (e.g., 90) can be coupled to a second layer (e.g., 66) by bonding (e.g., via adhesive, welding, application of heat and pressure, and/or the like) the first layer to the second layer or to another layer that is coupled to the second layer, placing the first layer in contact with the second layer or with another layer that is coupled to the second layer, through use of fastener(s) (e.g., screw(s), bolt(s), rivet(s), pin(s), and/or the like), and/or the like. For example, in a stack of layers (e.g., 66 and/or 90), each of the layers, whether or not removable from the stack, is coupled to each other of the layers. To be clear, resilient layers of the present disclosure can be characterized as components of the plates to which they are or can be coupled or as components of the tools that include those plates. Further, any feature described herein as one of a resilient layer of a plate can also be one of a resilient layer of a tool.

More particularly, resilient layer 90 can be coupled to metal layer 66 such that the resilient layer covers at least a portion of (e.g., at least a majority of) upper surface 70 of the metal layer. For example, substantially all of resilient layer 90 can overlie upper surface 70, and the resilient layer can have a surface area 94 that is at least 50% (e.g., including 100%) of a surface area 98 of the upper surface. As used herein, a layer (e.g., 90) can be said to cover a portion of a surface (e.g., 70) even if additional layer(s) are present between the layer and the portion of the surface. In some plates, each of the layers (e.g., 66 and/or 90) can have a length (e.g., 102) that is substantially the same as a length (e.g., 102) of at least one other of the layers and/or a width (e.g., 106) that is substantially the same as a width (e.g., 106) of at least one other of the layers.

Resilient layer 90 can have any suitable thickness 110 (FIG. 2C), such as, for example, a thickness that is greater than or substantially equal to any one of, or between any two of: 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 1.00, 1.10, 1.20, 1.30, 1.40, 1.50, 1.60, 1.70, 1.80, 1.90, 2.00, 2.50, or 3.00 mm (e.g., approximately 0.13, 0.15, 0.25, or 0.50 mm). In plate 14a, resilient layer 90 comprises polytetrafluoroethylene; in other plates, resilient layer(s) (e.g., 90) can comprise this and/or any other suitable resilient material, such as, for example, silicon, polyimide, an elastomer, a gasket material, and/or the like. In some plates (e.g., 14a), resilient layer(s) (e.g., 90), or at least an outermost one of the resilient layer(s) that contacts a stack of one or more laminae (e.g., 22) when the stack is disposed on the plate, can comprise a material selected to prevent the resilient layer(s) from bonding to the stack, and, in some instances, to one another. For example, the resilient layer(s) can comprise a material having a glass transition temperature that is higher than a glass transition temperature of a matrix material (e.g., 146, described below) of the stack. A resilient layer (e.g., 90) can increase a plate's (e.g., 14a) ability to encourage an even application of pressure between pressing elements (e.g., 18a and 18b) and a stack of one or more laminae (e.g., 22) by, for example, deforming to compensate for irregularities on and/or unevenness of pressing surface(s) (e.g., 30) of the pressing elements, variations in the thickness of the stack, and/or the like.

Resilient layer(s) (e.g., 90) of the present plates (e.g., 14a) can comprise fibers. For example, and referring additionally to FIG. 3, resilient layer 90 includes fibers 118 dispersed within the resilient material of the layer. Fibers 118 of resilient layer 90 can be arranged in a woven configuration; for example, the resilient layer can include a first set of fibers 122a aligned with a first direction 126a and a second set of fibers 122b aligned with a second direction 126b that is angularly disposed (e.g., at an angle of approximately 90 degrees) relative to the first direction, where the first set of fibers is woven with the second set of fibers. As used herein, “aligned with” means within 10 degrees of parallel to. In plate 14a, fibers 118 of resilient layer 90 comprise glass fibers; in other plates, fibers (e.g., 118) of a resilient layer (e.g., 90) can comprise these and/or any other suitable fibers, such as, for example, carbon fibers, aramid fibers, polyethylene fibers, polyester fibers, polyamide fibers, ceramic fibers, basalt fibers, steel fibers, and/or the like. In some plates, fibers (e.g., 118) of a resilient layer (e.g., 90) can be arranged in a non-woven configuration; for example, the fibers can be arranged such that substantially all of the fibers are aligned in a single direction, the fibers can comprise discontinuous or short fibers, and/or the like.

For further example, the present plates can include resilient layer(s) having fibers (e.g., of any type described above) arranged as a fabric and/or mat (e.g., a woven fabric and/or mat, a chopped strand fabric and/or mat, and/or the like), whether or not those fibers are dispersed within a resilient material as described above with respect to FIG. 3. Such a fabric and/or mat can include, for example, a glass fiber mat, a layer of asbestos, or the like.

Plate 14a is provided by way of example, as the present plates can include any suitable number of metal layer(s) (e.g., 66) (e.g., 0, 1, 2, 3, or more metal layer(s)) and resilient layer(s) (e.g., 90) (e.g., 0, 1, 2, 3, 4, 5, 6, 7, 8, 9, 10, or more resilient layer(s)), and such layer(s) can be stacked in any suitable order. In plates having two or more metal layers (e.g., 66) and/or two or more resilient layers (e.g., 90), the metal layers can, but need not, comprise the same material and/or have the same thickness (e.g., 78), and the resilient layers can, but need not, comprise the same material and/or have the same thickness (e.g., 110). Plates having two or more layers (e.g., 66 and/or 90) can have a thickness (e.g., 130, FIG. 2C), measured through each of the layers, that is greater than or substantially equal to any one of, or between any two of: 0.40, 0.45, 0.50, 0.55, 0.60, 0.65, 0.70, 0.75, 0.80, 0.85, 0.90, 1.00, 1.10, 1.20, 1.30, 1.40, 1.50, 1.60, 1.70, 1.80, 1.90, 2.00, 2.10, 2.20, 2.30, 2.40, 2.50, 3.00, 3.50, 4.00, 4.50, 5.00, 5.50, 6.00, 7.00, 8.00, 9.00, or 10.00 mm (e.g., less than approximately 6.00 mm). In general, a thinner plate may be more effective than a thicker plate at transferring heat between a pressing element (e.g., 18a or 18b) and a stack of one or more laminae (e.g., 22).

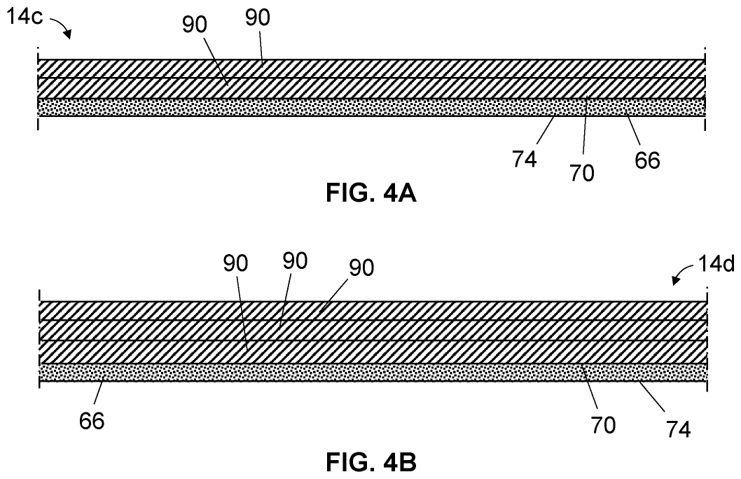

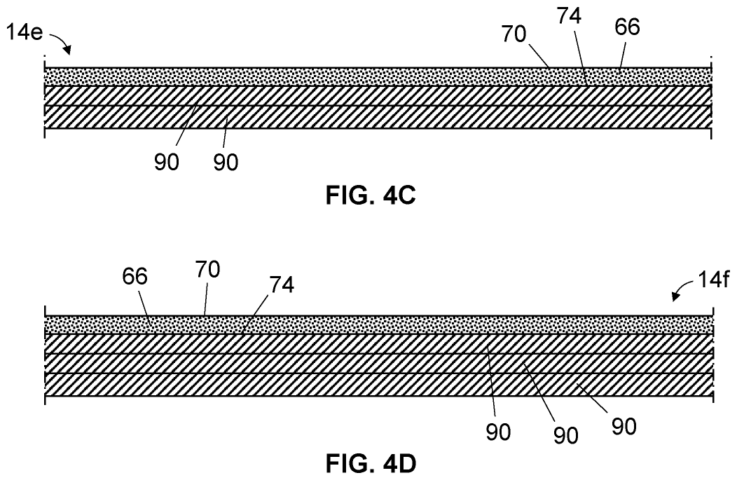

Referring now to FIG. 4A, shown is a plate 14c having two resilient layers 90, each coupled to a metal layer 66 such that the resilient layer covers at least a portion of (e.g., at least a majority of) an upper surface 70 of the metal layer. In plate 14c, metal layer 66 can comprise stainless steel and can have a thickness 78 of approximately 0.50 mm. Each of resilient layers 90 can comprise fiber-reinforced polytetrafluoroethylene and can have a thickness 110 of approximately 0.25 mm.

Referring now to FIG. 4B, shown is a plate 14d having three resilient layers 90, each coupled to a metal layer 66 such that the resilient layer covers at least a portion of (e.g., at least a majority of) an upper surface 70 of the metal layer. In plate 14d, metal layer 66 can comprise stainless steel and can have a thickness 78 of approximately 0.50 mm. Each of resilient layers 90 can comprise fiber-reinforced polytetrafluoroethylene, the one of the resilient layers that is closest to metal layer 66 can have a thickness 110 of approximately 0.50 mm, and the others of the resilient layers can each have a thickness 110 of approximately 0.25 mm.

In some plates, resilient layer(s) (e.g., 90) can be coupled to a metal layer (e.g., 66) such that at least one of the resilient layer(s) covers at least a portion of (e.g., at least a majority of) a lower surface (e.g., 74) of the metal layer. For example, FIG. 4C depicts a plate 14e including two resilient layers 90, each coupled to a metal layer 66 such that the resilient layer covers at least a portion of (e.g., at least a majority of) a lower surface 74 of the metal layer. In plate 14e, metal layer 66 can comprise stainless steel and can have a thickness 78 of approximately 0.50 mm. Each of resilient layers 90 can comprise fiber-reinforced polytetrafluoroethylene, the one of the resilient layers that is closest to metal layer 66 can have a thickness 110 of approximately 0.25 mm, and the other of the resilient layers can have a thickness 110 of approximately 0.50 mm.

In plate 14e, upper surface 70 of metal layer 66 defines at least a portion of an uppermost surface of the plate such that, for example, the upper surface contacts a stack of one or more laminae (e.g., 22) when the stack is disposed on the plate. In this way, a surface finish of upper surface 70 can be selected to achieve a desired surface finish of a laminate formed by pressing the stack; for example, the upper surface can be smooth to achieve a smooth (e.g., glossy) surface finish of the laminate. While a metal layer (e.g., 66), due to, for example, its higher stiffness, may be more suited to performing this function than is a resilient layer (e.g., 90), in plates having a resilient layer (e.g., 90) that forms at least a portion of an uppermost surface of the plate, this function can be performed by selecting a surface finish of an upper surface of the resilient layer.

Referring now to FIG. 4D, shown is a plate 14f including three resilient layers 90, each coupled to a metal layer 66 such that the resilient layer covers at least a portion of (e.g., at least a majority of) a lower surface 74 of the metal layer. In plate 14f, metal layer 66 can comprise stainless steel and can have a thickness 78 of approximately 0.50 mm. Each of resilient layers 90 can comprise fiber-reinforced polytetrafluoroethylene, the one of the resilient layers that is closest to metal layer 66 can have a thickness 110 of approximately 0.15 mm, the one of the resilient layers that is farthest from the metal layer can have a thickness 110 of approximately 0.50 mm, and the other of the resilient layers can have a thickness 110 of approximately 0.25 mm.

In some plates that include two or more resilient layers (e.g., 90), the resilient layers can be coupled to a metal layer (e.g., 66) such that at least a first one of the resilient layers covers at least a portion of (e.g., at least a majority of) an upper surface (e.g., 70) of the metal layer, and at least a second one of the resilient layers covers at least a portion of (e.g., at least a majority of) a lower surface (e.g., 74) of the metal layer (e.g., the metal layer can be disposed between the first and second resilient layers). Some plates may not include a metal layer (e.g., 66); if such a plate includes two or more resilient layers (e.g., 90), at least a first one of the resilient layers can be characterized as having an upper surface and a lower surface, and each other of the resilient layers can coupled to the first resilient layer such that the other resilient layer covers at least a portion of (e.g., at least a majority of) the upper surface or the lower surface of the first resilient layer.

Plate 14a can include one or more tabs 174 that extend outwardly from layers 66 and 90. Tab(s) 174 can function as handle(s) for plate 14a, thereby facilitating transportation of the plate and any stacks of one or more laminae (e.g., 22) disposed on the plate (e.g., to and from pressing elements 18a and 18b). At least by serving as a point(s) of reference, tab(s) 174 can facilitate locating of plate 14a relative to a pressing element (e.g., 18a or 18b). Tab(s) 174 can each define an opening 178, which can, for example, be configured to receive a locating pin of a pressing element (e.g., 18a or 18b), a pin, projection, or hook of a conveyor (e.g., 290, described below), an end effector (e.g., 186, described below), and/or the like. In plate 14a, each of tab(s) 174 is unitary with metal layer 66; however, in other plates, tab(s) (e.g., 174) can be unitary with a resilient layer (e.g., 90) of the plate or can be coupled to layer(s) (e.g., 66 and/or 90) of the plate via fastener(s) (e.g., bolt(s), screw(s), rivet(s), and/or the like), adhesive, and/or the like. Such tab(s) (e.g., 174) may or may not be a feature of any of the plates described herein. In some plates, opening(s) (e.g., 178) can be defined through layer(s) (e.g., 66 and/or 90) of the plate.

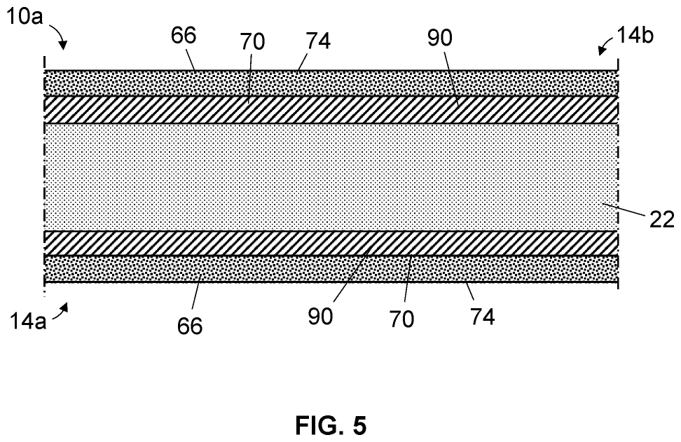

Referring now to FIG. 5, tool 10a can include two plates—plate 14a and a plate 14b that is substantially similar to plate 14a—each of which can be disposed on a respective side of a stack of one or more laminae (e.g., 22). Tool 10a is provided by way of example, as other tools can include any suitable plate(s) (1, 2, 3, 4, 5, or more plates), such as, for example, one or more of any of the plates described above (e.g., two of any one of the plates, such as two of plate 14c, one of any one of the plates and one of any other one of the plates, such as one of plate 14d and one of plate 14e, a single one of any of the plates, such as one of plate 14f, and/or the like). Some of the present tools can be used to simultaneously pre-heat, consolidate, and/or cool two or more stacks of laminae (e.g., 22) by, for example, disposing one or more plates of the tool between adjacent ones of the stacks of laminae.

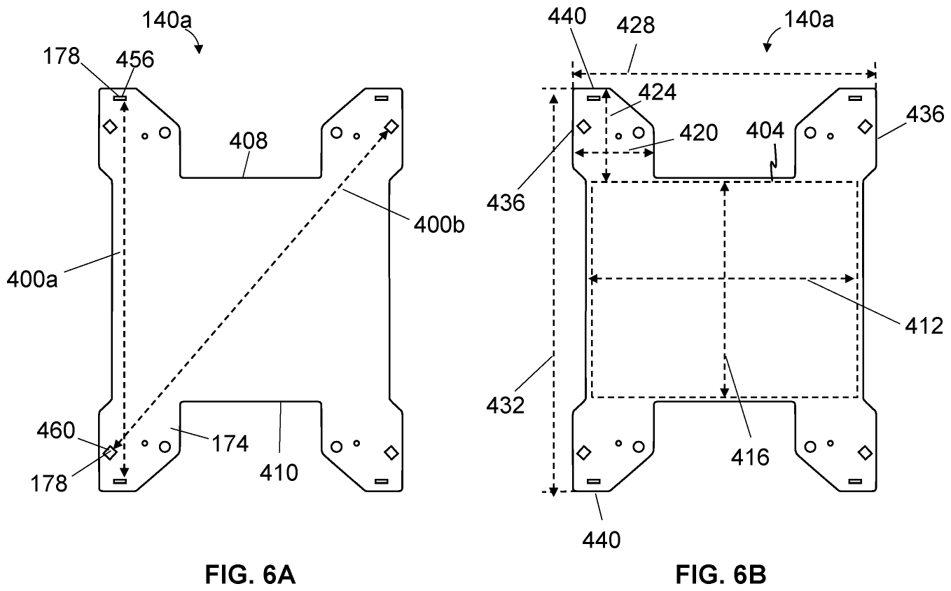

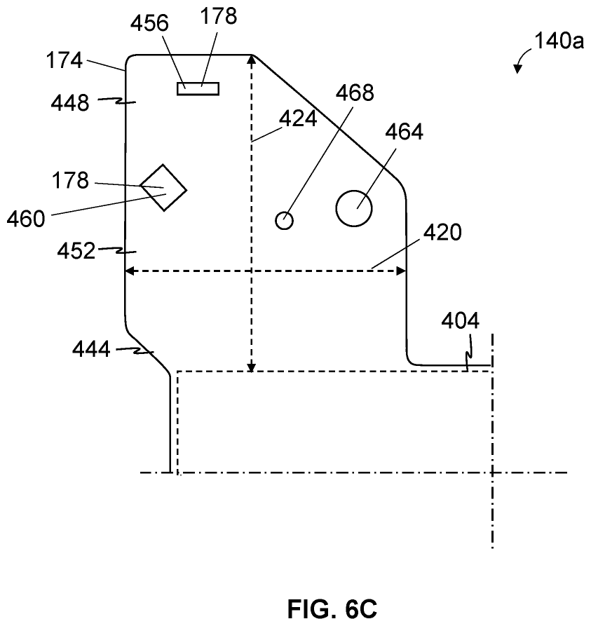

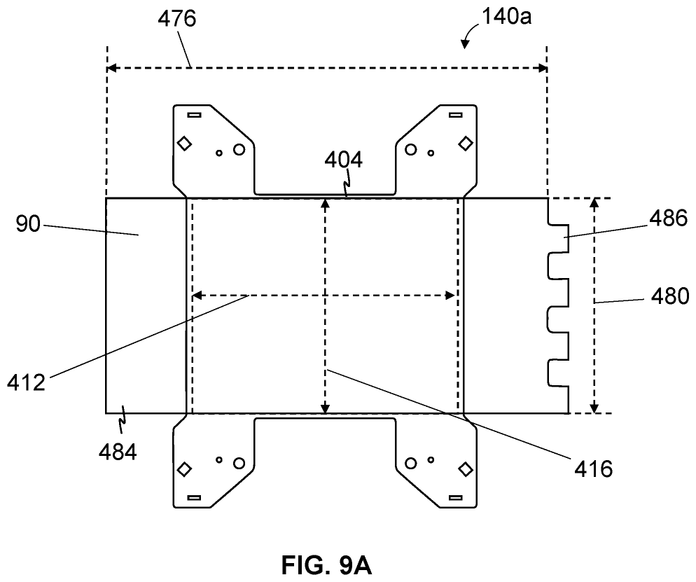

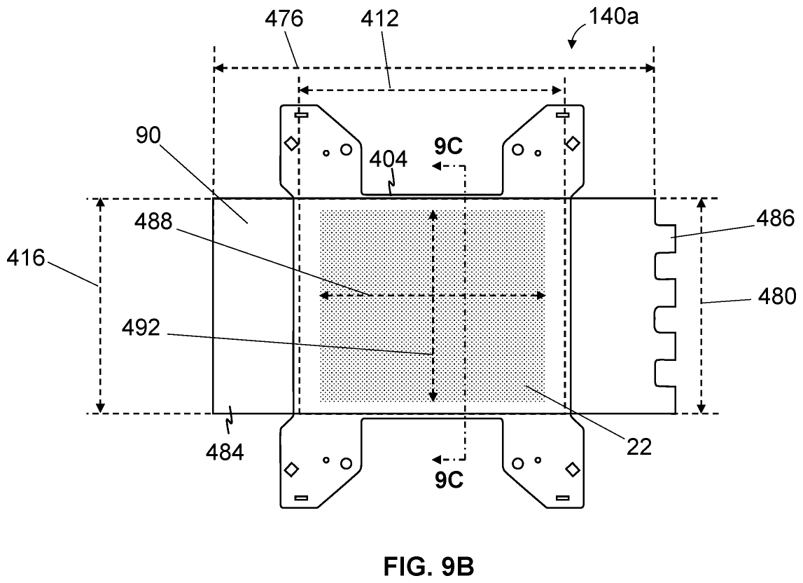

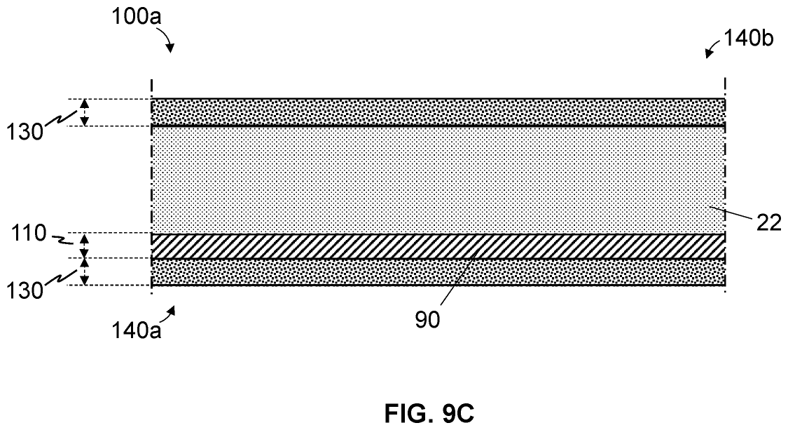

Referring now to FIGS. 6A-6C, shown is a plate 140a of a tool—which can also include a plate 140b that is substantially similar to plate 140a (tool 100a, FIG. 9C)—configured to be disposed on a respective side of a stack of one or more laminae (e.g., 22). Plate 140a comprises a rectangular center region 404 having a width 412, a length 416, a first widthwise edge 408, and a second widthwise edge 410. As shown, plate 140a can have four tabs 174: two extending outwardly from first widthwise edge 408, and two extending outwardly from second widthwise edge 410. Center region 404 can receive the stack, and tabs 174 can facilitate transportation of plate 140a and/or tool 100a via, for example, a conveyor and/or one or more grippers coupled to the tabs. While plate 140a comprises a rectangular center region, other plates can have a center region having any dimensions and shape suitable for receiving the stack, for example, circular, semicircular, elliptical, triangular, trapezoidal, polygonal, or the like. In some embodiments, a plate can have any suitable number of tabs extending outwardly from one or more edges of a center region of the plate (e.g., 1, 2, 3, 4, 5, 6, or more tabs).

Tabs 174 can be sized and positioned relative to center region 404 to minimize plate deformations when plate 140a is used to form a laminate. To illustrate, ones of tabs 174 extending from a same widthwise edge (e.g., one of 408 and 410) can be positioned such that a distance 428 between outermost edges 436 of the tabs, measured parallel to width 412, can be at least 5%, 10%, 15%, 20%, or 25% (e.g., at least 5%) larger than width 412 of center region 404. The extension of outermost edges 436 beyond width 412 can reduce interaction between tabs 174 and center region 404 and thereby reduce stresses within the plate caused by temperature differences between the tabs and the center region. Furthermore, ones of tabs 174 extending from different ones of widthwise edges 408 and 410 can be positioned such that a distance 432 between outermost edges 440 of the tabs, measured parallel to length 416, can be at least 20%, 30%, 40%, 50%, 60%, 70%, 80%, or 90% larger (e.g., at least 20% or at least 80% larger) than length 416 of center region 404. The lengthwise extension of each of tabs 174 from center region 404 provides a suitable means to facilitate transportation of plate 140a.

Tabs 174 can each have a shape selected to minimize plate 140a deformations when the plate is used to form a laminate. For example, tabs 174 can each have a width 420 measured parallel to width 412 and a length 424 measured parallel to length 416. For each of tabs 174, width 420 can vary along length 424 (e.g., each of tabs 174 widens and/or tapers). As shown, tabs 174 each can have a first portion 444 in which width 420 increases along length 424 (e.g., widening) and a second portion 448 in which width 420 decreases along length 424 (e.g., tapering), where the first portion is closer to center region 404 than is the second portion (FIG. 6C). Moreover, tabs 174 each can have a maximum width that is at least 10%, 15%, 20%, 25%, 30%, 35%, 40%, 45%, or 50% larger (e.g., at least 10% larger) than width 420 of the tab at the widthwise edge from which it extends. Such lengthwise widening in first portion 444 further reduces interaction between center region 404 and tabs 174 in areas susceptible to deformation due to, for example, temperature differences. Furthermore, the tapering of each of tabs 174 in second portion 448 reduces the weight of plate 140a, further promoting transportability. Tabs 174 can each have a third portion 452, disposed between first portion 444 and second portion 448, in which width 420 is substantially constant along length 424 to, for example, maintain structural integrity of the tab. In other embodiments, a tab can have any suitable shape.

Tabs (e.g., 174) can each define one or more openings (e.g., 178) to, for example, further facilitate transportation of a plate (e.g., 140a) and/or tool (e.g., 100a). As shown, tabs 174 each define a plurality of openings 178 configured to permit coupling of the tab to a conveyor and/or a gripper. For example, at least one of openings 178 can be configured to be coupled to a pin, projection, or hook of a conveyor (e.g., 290, described below). Furthermore, at least one of openings 178 can be configured to be coupled to prongs (e.g., 194a, 194b, described below (e.g., a gripper)) of an end effector (e.g., 186, described below).

Each of openings 178 can have a different shape, orientation, and/or size than other ones of the openings. For example, a first opening 456 and a second opening 460 can each be rectangular, and a third opening 464 and a fourth opening 468 can each be circular. The different shapes, orientations, and/or sizes of openings 178 can enable tabs 174 to be coupled to different transportation mechanisms. For example, first opening 456 can be configured to be coupled to a first gripper and second opening 460 can be configured to be coupled to a second gripper different from the first gripper. In other embodiments, openings can have any size, orientation, and shape (e.g., elliptical, trapezoidal, polygonal, or the like) suitable for coupling with a conveyor and/or one or more grippers. In some embodiments, each of the openings can have the same shape, orientation, and/or size. In yet further embodiments, a tab can define any suitable number of openings, for example, 1, 2, 3, 4, 5, 6, 7, or 8 openings.

The relative positions of openings (e.g., 178) can also minimize plate deformations when a plate (e.g., 140a) and/or tool (e.g., 100a) is heated, pressed, and/or transported. As shown in FIG. 6A, a line 400a extending between first openings 456 of ones of tabs 174 extending from different ones of widthwise edges 408 and 410 can be contained within a planform of plate 140a. Furthermore, a line 400b extending between second openings 460 of ones of tabs 174 extending from different ones of widthwise edges 408 and 410 can also be contained within a planform of plate 140a. As used herein, a “planform” of a plate is the shape defined by a projection of the plate onto a horizontal plane when the plate is laying horizontally. When a transporting mechanism (e.g., a conveyor and/or one or more grippers) is coupled to openings 178, a load path resulting from forces exerted by the mechanism can be aligned with either of lines 400a and 400b, thereby reducing plate deformation due to those forces.

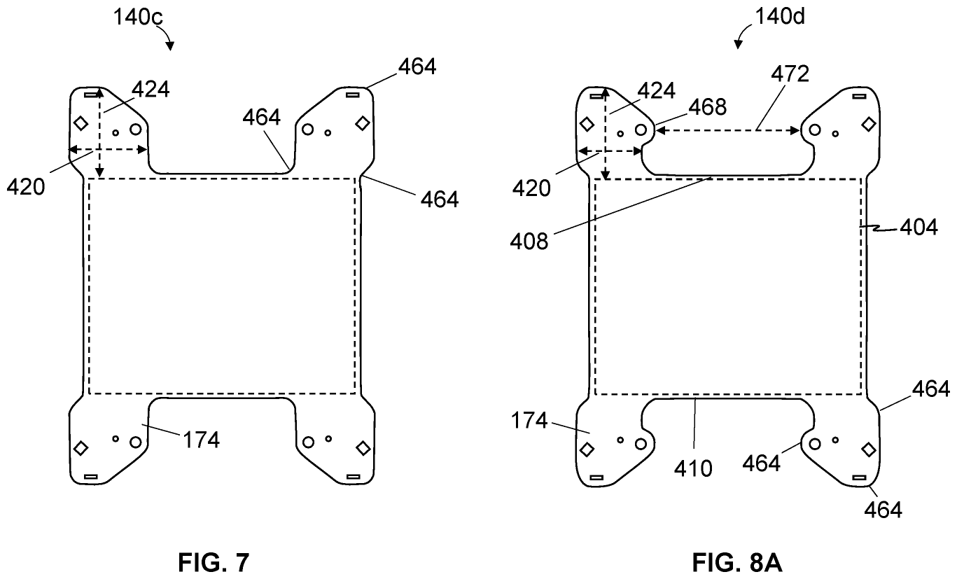

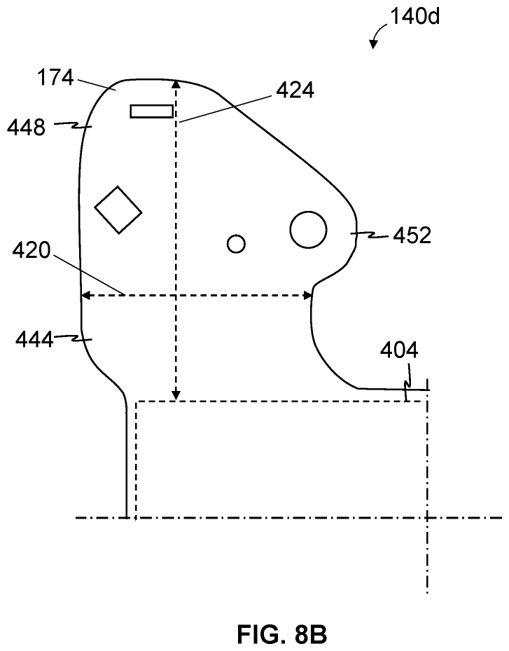

Turning now to FIGS. 7 and 8A-8B, shown are plates 140c and 140d, each of which can be substantially similar to plate 140a. The primary difference between plates 140a, 140c, and 140d is the shape of the tabs. Referring first to FIG. 7, tabs 174 of plate 140c can each have a width 420 that varies along a length 424 of the tab in substantially the same manner as do the widths of the tabs of plate 140a. To further minimize plate deformations, one or more edge portions 464 where edges of tabs 174 change direction (e.g., a corner) have increased radii (e.g., are more curved) when compared to the tabs of plate 140a. Referring now to FIGS. 8A-8B, tabs 174 of plate 140d can each have a width 420 that varies along a length 424 of the tab in a different manner than do the widths of the tabs of plate 140a. To illustrate, along length 424, width 420 can remain substantially constant in a first portion 444, increase to a maximum width of the tab in a third portion 452 (e.g., widen), and decrease in a second portion 448 (e.g., taper). Width 420 at center region 404 can be smaller than the maximum width (e.g., each of tabs 174 is necked) (FIG. 8B). Tabs 174 can each be shaped such that a distance 472 measured between innermost edges 468 of ones of tabs 174 extending from a same one of widthwise edges 408 and 410 decreases along length 424 in third portion 452. The shape of tabs 174 (e.g., the necking) reduces stresses caused by temperature differences between center region 404 and tabs 174. Each of tabs 174 can further have one or more edge portions 464 having increased radii when compared to the tabs of plate 140a.

FIGS. 9A-9B provide an illustration of the relative sizes and orientations of a resilient layer 90, a stack 22 of one or more laminae, and plate 140a. However, the depicted relationship between resilient layer 90, stack 22, and plate 140a is provided by way of illustration and is not limiting on the present plates and tools or methods of using the same. In some embodiments, for example, a resilient layer (e.g., 90) and a stack (e.g., 22) can be disposed on any suitable plate (e.g., any of 14a-14o (some of which are described below), 140a-140d, or a like plate) in substantially the same manner as described below with respect to plate 140a. In some embodiments, when a stack (e.g., 22) and a resilient layer (e.g. 90) are disposed between a top plate and a bottom plate of a tool (e.g., 100a), the top and bottom plates can have substantially similar sizes and orientations relative to the stack and the resilient layer.

Turning to FIG. 9A, resilient layer 90 can be disposed on plate 140a and, optionally, the resilient layer and the plate can be separate components (e.g., resilient layer 90 can be a loose resilient layer). Resilient layer 90 can be sized such that one or more portions 484 of the resilient layer do not overlie plate 140a (e.g., portion(s) 484 extend outwardly from plate 140a). For example, resilient layer 90 can be rectangular and have a width 476 larger than width 412 of center region 404. The oversizing of resilient layer 90 relative to plate 140a facilitates removal of the resilient layer from the plate by, for example, enabling the resilient layer to be pulled by at least one of portion(s) 484 (e.g., with one or more grippers) without interference of the plate. As shown, resilient layer 90 includes one or more protrusions 486 extending outwardly from one of the lengthwise edges of the resilient layer. However, in some embodiments, protrusion(s) (e.g., 486) can extend from any of the edges of a resilient layer (e.g. from one or more of the lengthwise edges and/or from one or more of the widthwise edges). Optionally, a resilient layer can have no protrusions.

Turning now to FIG. 9B, shown is plate 140a and resilient layer 90 underlying stack 22 such that resilient layer 90 is disposed between stack 22 and plate 140a. Plate 140a and resilient layer 90 can be sized to accommodate stack 22. Each of center region 404 and resilient layer 90 can underlie all of stack 22 (e.g., width 412 and width 476 can each be larger than or the same as width 488 of stack 22, and length 416 and length 480 can each be larger than or the same as length 492 of stack 22). As shown, center region 404 can be sized such that stack 22 spans at least 65%, 70%, 75%, 80%, 85%, 90%, 95%, or 100% (e.g., at least 80%) of the surface area of the face of center region 404 that faces stack 22. Sizing resilient layer 90 to underlie all of stack 22 promotes an even distribution of pressure on stack 22 when, for example, stack 22 and resilient layer 90 are disposed between plate 140a and plate 140b (e.g., as described below in FIG. 9C) and stack 22 is pressed (e.g., with a press 50). The size of plate 140a (e.g., the size of center region 404) relative to stack 22 provides a suitable area over which pressure and/or heat can be applied to stack 22 while minimizing boundary areas of plate 140a susceptible to stress resulting from, for example, temperature differences when the plate is heated.

Center region 404, resilient layer 90, and stack 22 are each depicted as rectangular, with resilient layer 90 having protrusion(s) 486 extending from one of its lengthwise edges; however, in other embodiments, a center region, resilient layer, and stack can have any suitable size and shape. For example, although—as shown—resilient layer 90 can be disposed on plate 140a such that resilient layer 90 does not overlie any of tabs 174 (e.g., length 480 is smaller than or substantially the same as length 416), in other embodiments a resilient layer can partially or completely overlie one or more tabs (e.g., each of or some of the tabs). In further embodiments, a resilient layer can extend outwardly from plate 140a in a lengthwise direction and not in a widthwise direction (e.g., length 480 can be larger than length 416, and width 476 can be smaller than or the same as width 412). In some embodiments, a center region of a plate, a resilient layer, and/or a stack of one or more laminae can be circular, semicircular, elliptical, triangular, trapezoidal, polygonal, or the like, and can have any suitable dimensions such that, for example, the resilient layer and the plate can each underlie all of the stack while one or more portions of the resilient layer do not overlie the plate.

Referring now to FIG. 9C, shown is a cross-sectional view of a tool 100a that can include two plates—plate 140a and a plate 140b that is substantially similar to plate 140a-taken along line 9C-9C of FIG. 9B. As shown, resilient layer 90 and stack 22 can be disposed within tool 100a (e.g., between plates 140a and 140b). Each of plates 140a and 140b can have a thickness 130 less than approximately 1 mm, 1.2 mm, 1.4 mm. 1.6 mm, 1.8 mm, 2.0 mm, 2.2 mm, or 2.4 mm (e.g., less than approximately 2 mm). Resilient layer 90 can have a thickness 110 less than approximately 1 mm, 1.2 mm, 1.4 mm, 1.6 mm, 1.8 mm, 2.0 mm, 2.2 mm, 2.4 mm, 2.6 mm, 2.8 mm, 3.0 mm, or 3.2 mm.

FIG. 10 shows plate 140a positioned on a pressing surface 30 of press 50. Pressing surface 30 can underlie or overlie (depending on whether the pressing surface is disposed above or below plate 140a) center region 404 and at least a portion of each of tabs 174. Pressing surface 30 can include a heating region 496 through which the pressing surface can transfer heat (e.g., with a heating element (e.g., 34)) to plate 140a. Pressing surface 30, or heating region 496 thereof, can span at least 60%, 65%, 70%, 75%, 80%, 85%, 90%, or 95% of (e.g., at least 90% of), or 100% of, center region 404. Sizing pressing surface 30 (or its heating region 496) similarly to center region 404 minimizes temperature differences in the center region when plate 140a is heated. Press 50 can comprise a thermal isolator 500 configured to minimize heat loss from heating region 496 to an outside environment.

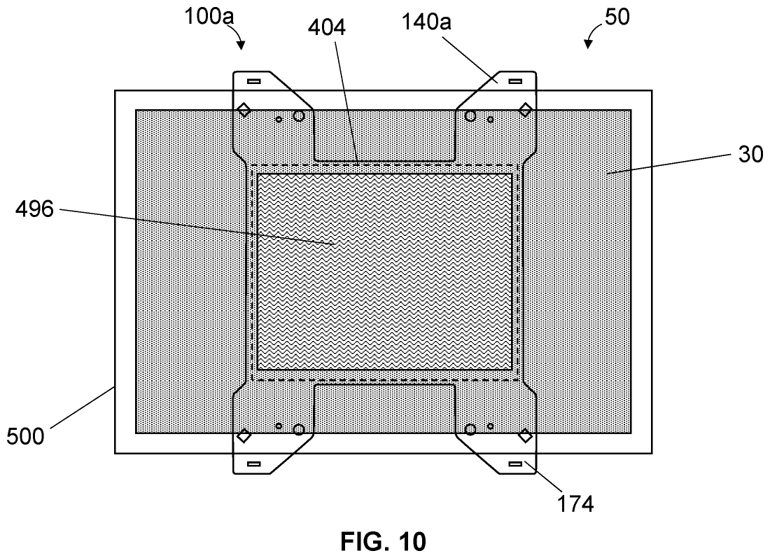

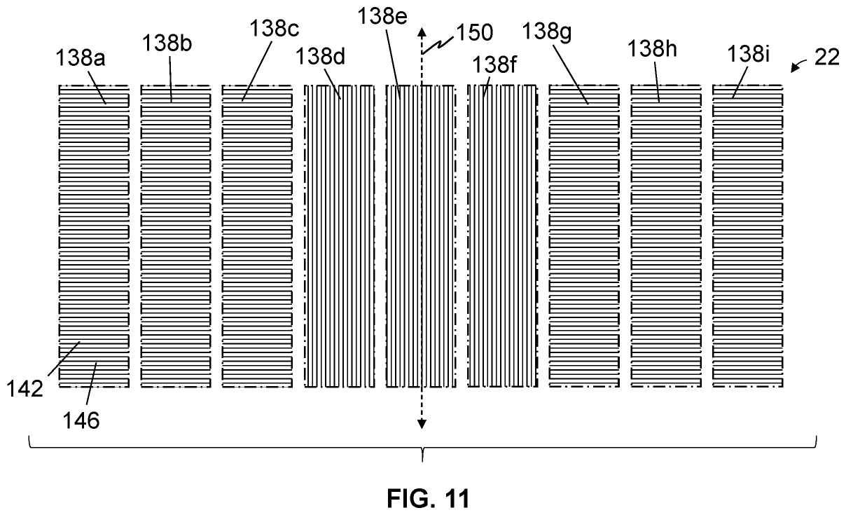

Provided by way of example, FIG. 11 depicts a stack of one or more laminae 22 that can be pre-heated, consolidated, and/or cooled using embodiments of the present tools. Stack 22 includes nine laminae, 138a-138i; however, stacks (e.g., 22) usable with the present tools can include any suitable number of lamina(e), such as, for example, 1, 2, 3, 4, 5, 6, 7, 8, 9, 10, 11, 12, 13, 14, 15, or more lamina(e).

In stack 22, each of laminae 138a-138i includes fibers 142 dispersed within a matrix material 146. Fibers (e.g., 142) of a lamina (e.g., any of laminae 138a-138i) can include any suitable fibers, such as, for example, any of the fibers described above. A matrix material (e.g., 146) of a lamina (e.g., any of laminae 138a-138i) can include any suitable matrix material, such as, for example, a thermoplastic or thermoset matrix material. A suitable thermoplastic matrix material can include, for example, polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polystyrene sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. A suitable thermoset matrix material can include, for example, an unsaturated polyester resin, a polyurethane, bakelite, duroplast, urea-formaldehyde, diallyl-phthalate, epoxy resin, an epoxy vinylester, a polyimide, a cyanate ester of a polycyanurate, dicyclopentadiene, a phenolic, a benzoxazine, a co-polymer thereof, or a blend thereof. To illustrate, a lamina (e.g., any of laminae 138a-138i) including fibers (e.g., 142) can have a pre-consolidation fiber volume fraction that is greater than or substantially equal to any one of, or between any two of: 40, 45, 50, 55, 60, 65, 70, 75, 80, 85, or 90%.

In stack 22, each of laminae 138a-138i is a unidirectional lamina, or a lamina having fibers 142, substantially all of which are aligned with a single direction. More particularly, in each of the laminae, the fibers are either aligned with a long dimension of the stack (e.g., measured in direction 150) (e.g., laminae 138d-138f, each of which may be characterized as a 0-degree unidirectional lamina) or are aligned with a direction that is perpendicular to the long dimension of the stack (e.g., laminae 138a-138c and laminae 138g-138i, each of which may be characterized as a 90-degree unidirectional lamina). Some stacks can include unidirectional lamina(e) that each have fibers (e.g., 142) that are aligned with any suitable direction, such as, for example, a direction that is angularly disposed relative to a long dimension of the stack at an angle that is greater than or substantially equal to any one of, or between any two of: 0, 5, 10, 15, 20, 25, 30, 35, 40, 45, 50, 55, 60, 65, 70, 75, 80, 85, or 90 degrees.

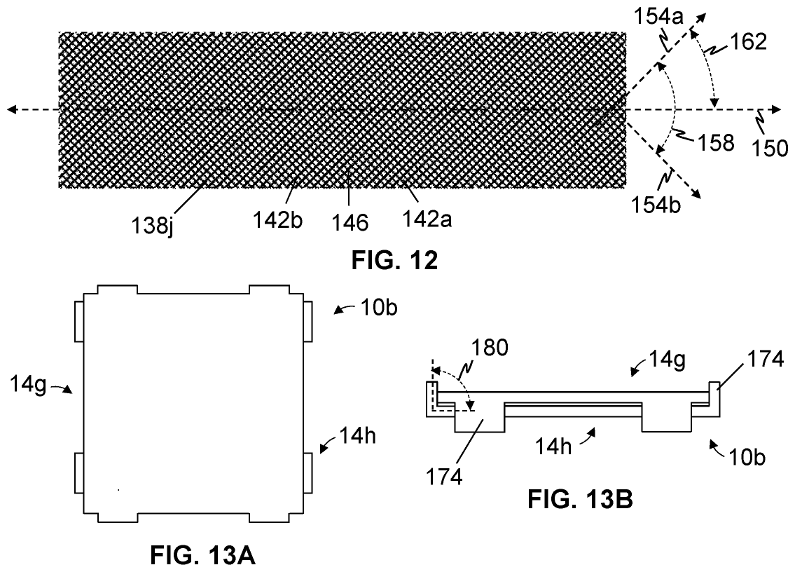

Some stacks can include lamina(e) having fibers (e.g., 142) arranged in a woven configuration (e.g., as in a lamina having a plane, twill, satin, basket, leno, mock leno, or the like weave). Referring additionally to FIG. 12, lamina 138j, which can be included in a stack, can include a first set of fibers 142a aligned with a first direction 154a and a second set of fibers 142b aligned with a second direction 154b that is angularly disposed relative to the first direction, where the first set of fibers is woven with the second set of fibers. A smallest angle 158 between first direction 154a and second direction 154b can be greater than or substantially equal to any one of, or between any two of: 5, 10, 15, 20, 25, 30, 35, 40, 45, 50, 55, 60, 65, 70, 75, 80, 85, or 90 degrees. A smallest angle 162 between first direction 154a and a long dimension of a stack including lamina 138j (e.g., measured in direction 150) can be greater than or substantially equal to any one of, or between any two of: 0, 5, 10, 15, 20, 25, 30, 35, 40, 45, 50, 55, 60, 65, 70, 75, 80, 85, or 90 degrees.

In stack 22, laminae 138a-138i are arranged in a 90, 90, 90, 0, 0, 0, 90, 90, 90 lay-up. Other stacks can include any suitable lamina(e), including one or more of any lamina described above, arranged in any suitable lay-up, whether symmetric or asymmetric.

Some stacks of one or more laminae (e.g., 22) can include sheet(s), film(s), core(s) (e.g., porous, non-porous, honeycomb, and/or the like core(s)), and/or the like. Such sheet(s), film(s), and/or core(s) may or may not comprise fibers (e.g., 142) and can comprise any material described above as a matrix material (e.g., 146).

As described above, the present tools (e.g., 10a) can be configured to encourage an even application of pressure to a stack of one or more laminae (e.g., 22) by pressing elements (e.g., 18a and 18b). As effective pre-heating, consolidation, and/or cooling of thin stacks of one or more laminae may be particularly susceptible to uneven applications of such pressure, the present tools (e.g., 10a) may be suited for use in pre-heating, consolidating, and/or cooling of such thin stacks. For example, such a stack can have a pre-consolidation thickness, measured through each of its lamina(e), that is less than or substantially equal to any one of, or between any two of: 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mm. For further example, lamina(e) of such a stack can each have a pre-consolidation thickness that is less than or substantially equal to any one of, or between any two of: 0.05, 0.10, 0.15, 0.20, 0.25, 0.30, 0.35, 0.40, 0.45, or 0.50 mm (e.g., between approximately 0.13 mm and approximately 0.16 mm). For yet further example, a laminate formed by consolidating such a stack can have a thickness that is less than or substantially equal to any one of, or between any two of: 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 mm (e.g., less than approximately 2.00, 1.75, 1.50, or 1.25 mm).

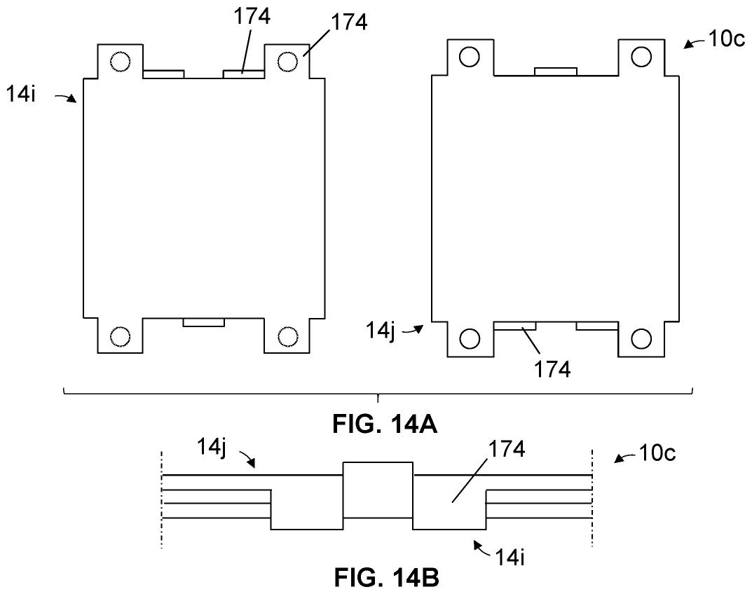

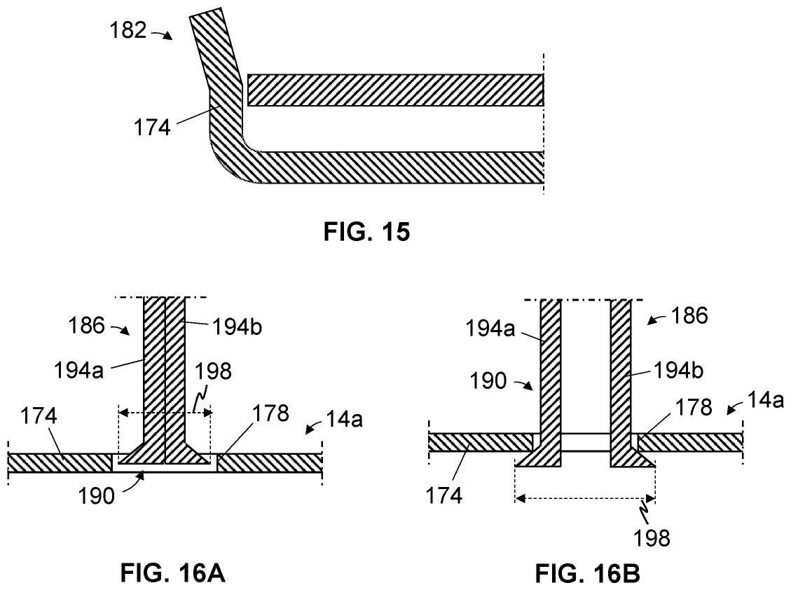

In plate 14a, tab(s) 174 are aligned with layers 66 and 90, and in plate 140a, tabs 174 are aligned with center region 404; however, in other plates, tab(s) of the plate can be angularly disposed relative to layer(s) of the plate. Referring additionally to FIGS. 13A and 13B and FIGS. 14A and 14B, shown are tools 10b and 10c, respectively. For each of these tools, at least one of the plates (e.g., 14g and/or 14h for tool 10b and 14i and/or 14j for tool 10c) includes tab(s) 174 that are angularly disposed relative to layer(s) of the plate. To illustrate, an angle 180 between at least a portion of such a tab and its respective layer(s) can be less than or substantially equal to any one of, or between any two of: 20, 25, 30, 35, 40, 45, 50, 55, 60, 65, 70, 75, 80, or 90 degrees. In this way, for tools 10b and 10c, tab(s) 174 of one of the plates can engage the other of the plates when the plates are coupled together, thereby locating the plates relative to one another. Referring additionally to FIG. 15, in some plate(s), at least a portion (e.g., 182) of a tab (e.g., 174) of the plate can be angularly disposed at a non-perpendicular angle relative to layer(s) of the plate; such a portion can facilitate coupling of the plate to another plate.

FIGS. 16A and 16B depict an illustrative method for handling plate(s) (e.g., 14a) of the present tools. As shown, an end effector (e.g., 186) can be coupled to plate (e.g., 14a) via one of its opening(s) (e.g., 178) so that the end effector can be used to transport and/or position the plate. In some tools, two or more plates of the tool can have opening(s) (e.g., 178) that are aligned such that, for example, an end effector (e.g., 186) can be used to transport and/or position the two or more plates simultaneously. Some plates can include one or more protrusions configured to be coupled to an end effector.

Such an end effector can comprise any suitable end effector, and the following description of end effector 186 is provided by way of illustration. End effector 186 can include a distal end 190 configured to be disposed through an opening (e.g., 178) of a plate (e.g., 14a). More particularly, distal end 190 of end effector 186 can include a first prong 194a and a second prong 194b, where the prongs are movable relative to one another between a first position (e.g., FIG. 16A) and a second position (e.g., FIG. 16B) in which a transverse dimension 198 of the distal end is larger than when the prongs are in the first position. When prongs 194a and 194b are in the first position, distal end 190 of end effector 186 may be capable of passing through the opening, and, when the prongs are in the second position, the distal end may not be capable of passing through the opening. In this way, end effector 186 may be coupled to the plate by passing distal end 190 of the end effector through the opening when prongs 194a and 194b are in the first position and subsequently moving the prongs toward the second position.

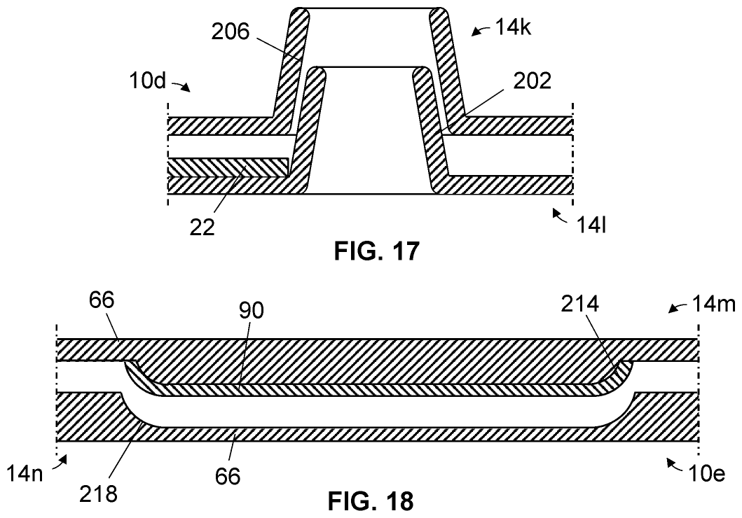

FIG. 17 depicts another embodiment 10d of the present tools. Tool 10d can include a first plate 14k and a second plate 14l, where at least one of the plates includes one or more protrusions 202, and at least one of the plates includes one or more recesses 206, each configured to receive a respective one of the protrusion(s) to couple the first plate to the second plate. As shown, protrusion(s) (e.g., 202 and/or other protrusion(s)) of a plate (e.g., 141) can function to locate a stack of one or more laminae (e.g., 22) relative to the plate. For a given plate (e.g., 14k and/or 14l), protrusion(s) (e.g., 202) and/or recess(es) (e.g., 206) of the plate can extend from and/or be defined by its layer(s) (e.g., 66 and/or 90) and/or its tab(s) (e.g., 174). Such protrusion(s) (e.g., 202) and recess(es) (e.g., 206) may or may not be a feature of any of the plates described herein.

FIG. 18 depicts another embodiment 10e of the present tools. Tool 10e can be used to form a laminate having non-planar portion(s). For example, tool 10e can include a first plate 14m and a second plate 14n, each having an uppermost surface that includes one or more curved portions. For example, the uppermost surface of plate 14m includes convex portions 214, and the uppermost surface of plate 14n includes concave portions 218. Each of plates 14m and 14n can have a lowermost surface that is planar, to, for example, facilitate use of tool 10e with pressing elements that have planar pressing surfaces (e.g., 30). When a stack of one or more laminae (e.g., 22) is pressed between plates (e.g., 14m and 14n), the stack can assume a shape that corresponds to the uppermost surfaces of the plates; thus, at least by selecting the geometry of the uppermost surfaces, a desired shape for a laminate can be achieved. Such an uppermost surface having curved portion(s) may or may not be a feature of any of the plates described herein.

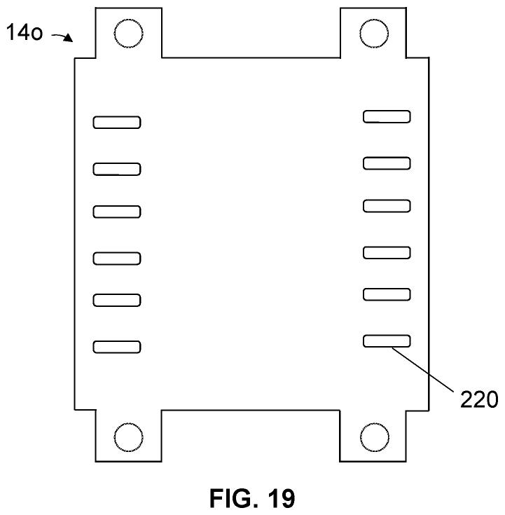

FIG. 19 depicts a plate 14o that may be suitable for use in some of the present tools. During use, some portions of a plate, such as a center of the plate, may be exposed to higher temperatures than other portions of the plate, such as a periphery of the plate, and such uneven heating may cause distortion of the plate. To mitigate such distortion, plate 14o defines one or more openings 220 through at least one of (e.g., each of) its layer(s). Such opening(s) (e.g., 220) may or may not be a feature of any of the plates described herein.

Some embodiments of the present methods for forming one or more laminates comprise disposing one or more stacks of one or more laminae (e.g., 22) between a bottom plate (e.g., any of plates 14a-14o and 140a-140d or a like plate) and a top plate (e.g., any of plates 14a-14o and 140a-140d, or a like plate). In some methods, the disposing can be performed such that, for example, the stack(s) are disposed between the top and bottom plates as described above with respect to plate 140a and/or tool 100a. Although some methods comprise disposing the stack(s) between a top and a bottom plate, other methods can comprise disposing the stack(s) on a single plate (e.g., one of a top plate and a bottom plate).

In some methods, at least one of the top and bottom plates includes one or more resilient layers (e.g., 90) (e.g., integrated resilient layer(s)). In other methods, the resilient layer(s) are not a component of either of the top and bottom plates (e.g., loose resilient layer(s)). Some methods using loose resilient layer(s) can comprise disposing one of the resilient layer(s) on one of the top and bottom plates before disposing the stack(s) between the top and bottom plates.

Some methods comprise transporting the stack(s) to a press (e.g., 50) using a conveyor and/or one or more grippers. In some methods, the transporting comprises using a conveyor or one or more grippers coupled tabs (e.g., 174) extending outwardly from a center region (e.g., 404) of at least one of the plates. In some methods, the transporting comprises coupling the conveyor or the same one of the gripper(s) to each of a first opening defined by one of the tabs of the top plate and a second opening defined by one of the tabs of the bottom plate, the second opening being aligned with the first opening. In some methods, the transporting comprises, for at least one of the top and bottom plates, coupling the conveyor or different ones of the gripper(s) to each of a first opening defined by one of the tabs of the plate and a second opening defined by one other of the tabs of the plate, wherein a straight line that extends between the first opening and the second opening lies completely within a planform of the plate.

Some methods comprise consolidating the stack(s) at least by pressing the top and bottom plates between pressing surfaces (e.g., 30) of pressing elements (e.g., 18a and 18b) of a press (e.g., 50) to form one or more laminates. In some methods, during the pressing, at least one of the resilient layer(s) is in contact with the stack(s). In some methods, for each of the top and bottom plates, at least 90% of the center region is disposed between the pressing surfaces. In some methods, at least a portion of each of the tabs of the top and bottom plates is not disposed between the pressing surfaces.

In some methods, at least one of the one or more laminae (e.g., any of laminae 138a-138j, or a like lamina) of at least one of the stack(s) comprises fibers (e.g., 142) dispersed within a matrix material (e.g., 146). In some methods, after the consolidating, each of the laminate(s) formed from the stack(s) has a thickness that is less than approximately 2.0 mm. Some methods comprise, after the consolidating, removing the laminate(s) formed from the stack(s) from between the top and bottom plates.

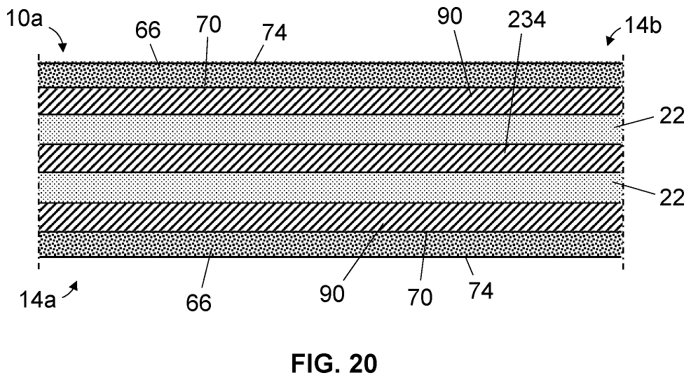

Referring additionally to FIG. 20, in some methods, the one or more stacks comprise two or more stacks, and the disposing comprises disposing one or more resilient layers (e.g., 234) between adjacent ones of the stacks. Such resilient layer(s) (e.g., 234) can comprise polytetrafluoroethylene, silicon, polyimide, an elastomer, a gasket material, and/or the like. Such resilient layer(s) (e.g., 234) can be a component (e.g., a resilient layer 90) of a plate (e.g., any of plates 14a-14o and 140a-140d, or a like plate) that is disposed between the adjacent ones of the stacks.

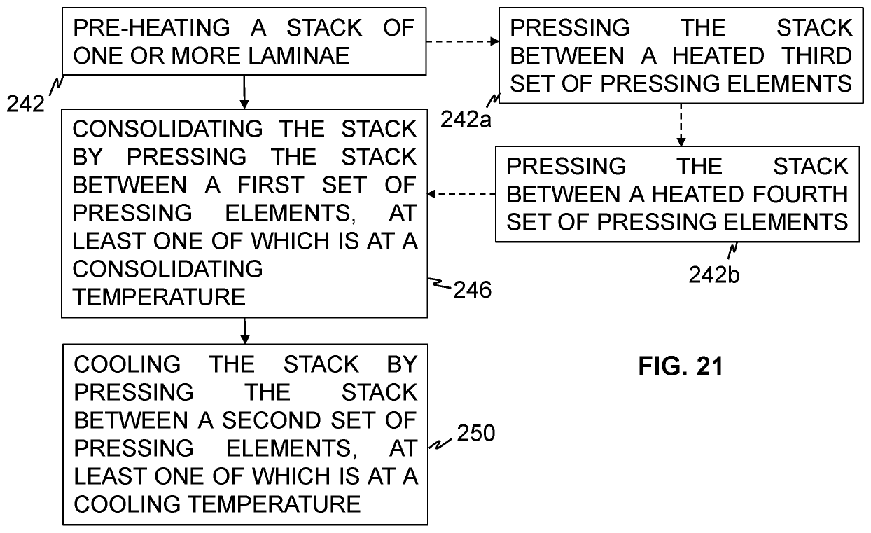

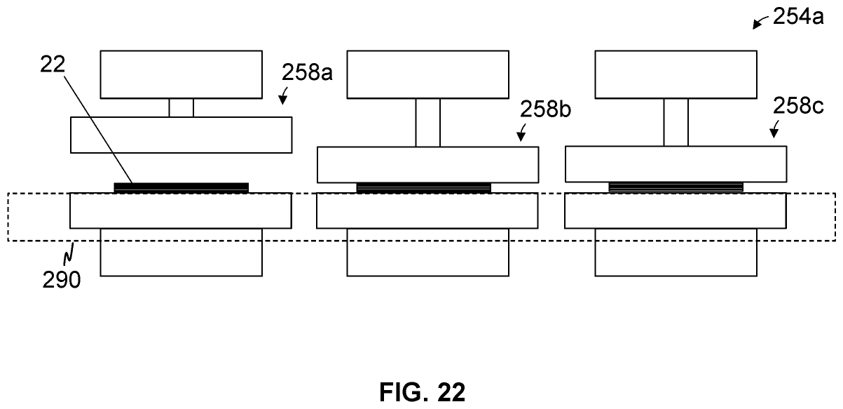

FIG. 21 depicts embodiments of the present methods for forming laminates. As described below, in some methods, a laminate can be formed by pre-heating a stack of one or more laminae (e.g., 22) (e.g., step 242), consolidating the stack (e.g., step 246), and cooling the stack (e.g., step 250). Embodiments of the present systems (e.g., 254a, FIG. 22; 254b, FIG. 26) are referenced to illustrate methods of FIG. 21; however, these systems are not limiting on those methods, which can be performed using any suitable system.

Some methods comprise a step 242 of pre-heating a stack of one or more laminae (e.g., 22) by applying heat from a heat source to the stack. The heat source can comprise any suitable heat source, such as, for example, a heated set of pressing elements (e.g., 258a, described below), an infrared heat source, a hot air oven, and/or the like. During the pre-heating step, a temperature of the heat source and/or the stack (e.g., a temperature to which the stack can be brought) can be any suitable temperature, such as, for example, a temperature that is greater than or substantially equal to any one of, or between any two of: 150, 160, 170, 180, 190, 200, 210, 220, 230, 240, 250, 260, 270, 280, 290, 300, 310, 320, 330, 340, 350, 360, 370, 380, 390, or 400° C. (e.g., between approximately 210° C. and approximately 400° C., approximately 240° C., and/or the like).

Referring additionally to FIG. 22, in some methods, the heat source comprises a heated set of pressing elements 258a (e.g., including a pressing element 18a and a pressing element 18b), and the pre-heating comprises a step 242a of pressing the stack between the set of pressing elements. Set of pressing elements 258a can be heated in that, for example, at least one of the pressing elements includes a heating element (e.g., 34, FIG. 1), one or more interior passageways (e.g., 38, FIG. 1) through which a heated fluid is passed, and/or the like. A pressure applied to the stack by set of pressing elements 258a can be any suitable pressure, such as, for example, a pressure that is less than or substantially equal to any one of, or between any two of: 0.10, 0.15, 0.20, 0.25, 0.30, 0.35, 0.40, 0.45, 0.50, 0.60, 0.70, 0.80, 0.90, 1.00, 1.25, 1.50, 1.75, 2.00, 2.25, 2.50, 3.00, 3.50, 4.00, or 5.00 bar gauge (e.g., between approximately 0.25 bar gauge and approximately 2.00 bar gauge, between approximately 0.5 bar gauge and approximately 1.0 bar gauge, approximately 0.5 bar gauge, and/or the like). Set of pressing elements 258a, as with other sets of pressing elements described herein, can be components of a press (e.g., 50).

During the pre-heating step, the stack can be exposed to heat from the heat source (e.g., pressed between heated set of pressing elements 258a) for any suitable period of time, such as, for example, a period of time that is greater than or substantially equal to any one of, or between any two of: 5, 10, 15, 20, 25, 30, 35, 40, 45, 50, 55, 60, 70, 80, 90, 100, 110, or 120 seconds, or 1, 2, 3, 4, or 5 minutes (e.g., approximately 40 seconds, approximately 120 seconds, and/or the like). Some methods may not include a pre-heating step (e.g., 242).

Some methods comprise a step (e.g., 246) of consolidating the stack. More particularly, the stack can be consolidated by pressing the stack between a heated set of pressing elements 258b. During the consolidating step, a temperature of at least one of pressing elements 258b and/or the stack (e.g., a temperature to which the stack can be brought) can be any suitable temperature, such as, for example, a temperature that is greater than or substantially equal to any one of, or between any two of: 140, 150, 160, 170, 180, 190, 200, 210, 220, 230, 240, 250, 260, 270, 280, 290, 300, 310, 320, 330, 340, 350, 360, 370, 380, 390, or 400° C. (e.g., between approximately 140° C. and approximately 400° C., between approximately 165° C. and approximately 175° C., approximately 300° C., and/or the like). This temperature is sometimes referred to as a “consolidating temperature.” As used herein, “consolidating temperature,” and like terms “consolidating pressure,” “cooling temperature,” and “cooling pressure,” are each used to associate a parameter with a step (e.g., “consolidating temperature” is a temperature associated with the consolidating step); these terms, taken alone, do not define any particular values for the parameters. In some methods, the consolidating temperature can be lower than the temperature of the heat source and/or the stack during the pre-heating step.

During the consolidating step, a pressure applied to the stack by set of pressing elements 258b (a “consolidating pressure”) can be any suitable pressure, such as, for example, a pressure that is greater than or substantially equal to any one of, or between any two of: 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, or 25.0 bar gauge (e.g., approximately 13 bar gauge, approximately 20 bar gauge, and/or the like). In some methods, the consolidating pressure can be greater than the pressure applied to the stack during the pre-heating step. During the consolidating step, the stack can be pressed between set of pressing elements 258b for any suitable period of time, such as, for example, a period of time that is greater than or substantially equal to any one of, or between any two of: 5, 10, 15, 20, 25, 30, 35, 40, 45, 50, 55, 60, 65, 70, 75, 80, 90, 100, 110, or 120 seconds, or 1, 2, 3, 4, or 5 minutes (e.g., approximately 6, 10, 20, 60, or 120 seconds).

Some methods comprise a step (e.g., 250) of cooling the stack. More particularly, the stack can be cooled by pressing the stack between a set of pressing elements 258c, during which a temperature (a “cooling temperature”) of at least one of the pressing elements and/or the stack (e.g., a temperature to which the stack can be brought) is lower than the consolidating temperature. The cooling temperature can be any suitable temperature, such as, for example, a temperature that is less than or substantially equal to any one of, or between any two of: 10, 15, 20, 25, 30, 35, 40, 45, or 50° C. (e.g., between approximately 25° C. and approximately 30° C., approximately room temperature, and/or the like).

During the cooling step, a pressure applied to the stack by set of pressing elements 258c (a “cooling pressure”) can be any suitable pressure, such as, for example, a pressure that is greater than or substantially equal to any one of, or between any two of: 5.0, 5.5, 6.0, 6.5, 7.0, 7.5, 8.0, 8.5, 9.0, 9.5, 10.0, 10.5, 11.0, 11.5, 12.0, 12.5, 13.0, 13.5 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, or 25.0 bar gauge (e.g., approximately 13 bar gauge, approximately 20 bar gauge, and/or the like). In some methods, the cooling pressure can be greater than the pressure applied to the stack during the pre-heating step. During the cooling step, the stack can be pressed between set of pressing elements 258c for any suitable period of time, such as, for example, a period of time that is greater than or substantially equal to any one of, or between any two of: 5, 10, 15, 20, 25, 30, 35, 40, 45, 50, 55, 60, 65, 70, 75, 80, 90, 100, 110, or 120 seconds, or 1, 2, 3, 4, or 5 minutes (e.g., approximately 6, 10, 20, 60, or 120 seconds). In some methods, after the cooling step, the stack has a thickness of less than approximately 2.0 mm.

In some methods, the temperature of the heat source and/or the stack during the pre-heating step, the consolidating temperature, and/or the cooling temperature may differ. Some methods, at least by using respective sets of pressing elements (e.g., 258a, 258b, and 258c) for performing at least two of the pre-heating step, the consolidating step, and the cooling step, can reduce the need to vary a temperature of at least one of the sets of pressing elements when producing a laminate, thereby reducing the energy and time involved in producing the laminate. For example, using a single set of pressing elements to perform both the consolidating step and the cooling step may undesirably require at least one of the set of pressing elements to be heated to the consolidating temperature and cooled to the cooling temperature.

Some methods comprise coupling the stack to one or more plates (e.g., including one or more of any plate described above) such that each of the plate(s) is disposed between the stack and one of a set of pressing elements (e.g., 258a, 258b, 258c, and/or the like) when the stack is pressed by the set of pressing elements. As described above, such plate(s) can facilitate transportation of the stack (e.g., to and from the set of pressing elements), transfer of heat between one(s) of the set of pressing elements and the stack, encourage an even application of pressure to the stack by the set of pressing elements, and/or the like.

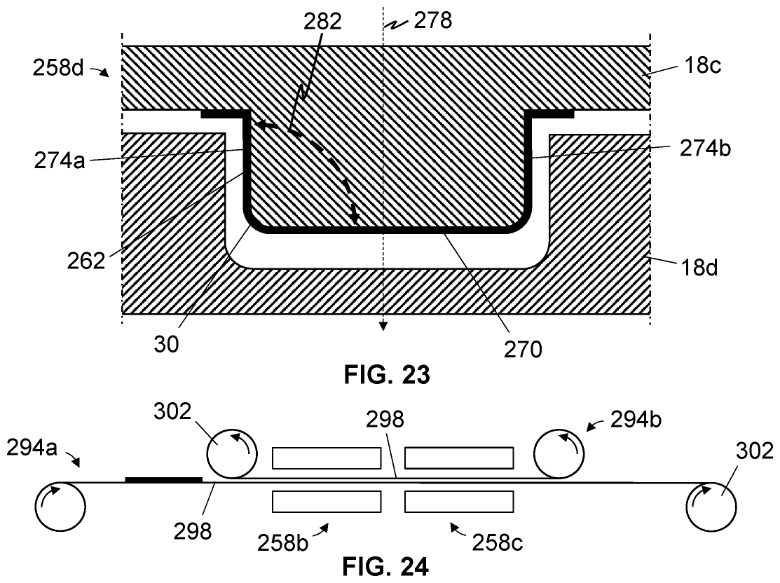

Referring additionally to FIG. 23, shown is a set of pressing elements 258d (18c and 18d) that may be suitable for use in some of the present methods and/or systems (e.g., as set of pressing elements 258a, 258b, and/or 258c). As shown, pressing element 18c can include a pressing surface 30 that is at least partially defined by a resilient layer 262. Resilient layer 262 can comprise any one or more of the resilient materials described above. In some embodiments, each of a set of pressing elements (e.g., 258a, 258b, 258c, 258d, and/or the like) can include a resilient layer (e.g., 262) that defines at least a portion of its pressing surface (e.g., 30).

Set of pressing elements 258d can be configured to produce a laminate having a non-planar shape. For example, pressing surface 30 of pressing element 18c can include a planar first portion 270 and one or more second portions (e.g., 274a and 274b) that are each angularly disposed relative to the first portion. First portion 270 can be substantially perpendicular to (e.g., within 10 degrees of perpendicular to) a closing direction 278 (e.g., a direction in which pressing elements 18c and 18d move relative to one another to press an object between the pressing elements). Each of the second portion(s) can be angularly disposed relative to first portion 270 at an angle 282 that is greater than or substantially equal to any one of, or between any two of: 10, 15, 20, 25, 30, 35, 40, 45, 50, 55, 60, 65, 70, 75, 80, 85, or 90 degrees. First portion 270 and/or one or more of the second portion(s) can be at least partially defined by resilient layer 262. During use of a given pressing element (e.g., 18c), portions of its pressing surface (e.g., 30) that are less aligned with a closing direction (e.g., 278) (e.g., first portion 270) may experience more pressure than portions of the pressing surface that are more aligned with the closing direction (e.g., second portions 274a and 274b). Using a resilient layer (e.g., 262) to define those portions of the pressing surface that are more aligned with the closing direction may increase the pressure experienced by those portions, promoting an even distribution of pressure across the pressing surface.

In some methods, one or more conveyors 290 can be used to transport a stack of one or more laminae (e.g., 22) between sets of pressing elements (e.g., between sets of pressing elements 258a and 258b, between sets of pressing elements 258b and 258c, and/or the like). To illustrate, each of conveyor(s) 290 can include one or more chains or belts to which the stack can be coupled such that movement of the chain(s) or belt(s) moves the stack. In instances in which the stack is coupled to one or more plates (e.g., including one or more of any plate described above), the stack can be coupled to the chain(s) or belt(s) via the plate(s). For example, one or more pins, projections, or hooks of the chain(s) or belt(s) can be received by one or more openings (e.g., 178) of the plate(s). The stack can be placed on or removed from conveyor(s) 290 via robotic arms (e.g., 334, FIG. 26).

In some embodiments, conveyor(s) 290 can be positioned such that a stack of one or more laminae (e.g., 22) transported by the conveyor(s) passes between the pressing elements of at least one set of pressing elements (e.g., 258a, 258b, 258c, and/or the like) so that the stack can be pressed by the pressing elements, but the conveyor(s) themselves do not pass between the pressing elements (e.g., to prevent the conveyor(s) from interfering with operation of the pressing elements). However, in embodiments in which conveyor(s) 290 include belt(s), at least one of the conveyors can be positioned such that a stack of one or more laminae (e.g., 22) transported by its belt(s) and its belt(s) pass between the pressing elements of at least one set of pressing elements (e.g., 258, 258b, 258c, and/or the like). Such belt(s) can encourage an even application of pressure to the stack by the pressing elements (e.g., functioning as resilient layer(s)), at least a portion of the belt(s) can become part of a laminate formed during consolidation of the stack, and/or the like.

For example, and referring additionally to FIG. 24, shown are two conveyors, 294a and 294b, that may be suitable for use in some embodiments of the present methods and/or systems (e.g., as conveyors 60). As shown, each of the conveyors includes a belt 298 supported by two or more rollers 302 (e.g., a head roller, a tail roller, one or more idler rollers, and/or the like). Belt 298 of each of the conveyors can be continuous (e.g., the belt can form a loop) or discontinuous (e.g., the belt can be unwound from one of rollers 302 and wound around one other of rollers 302).

Each of conveyors 294a and 294b can be positioned such that its belt 298 passes between the pressing elements of at least one set of pressing elements (e.g., 258b and 258c, as depicted); in this way, when a stack of one or more laminae (e.g., 22) transported by the belt is pressed by the pressing elements, the belt is disposed between the stack and one of the pressing elements. Belt 298 of each of the conveyors can comprise a resilient material, such as, for example, any one or more of the resilient materials described above. In at least these ways, belt(s) 298 of the conveyor(s) can encourage an even application of pressure to the stack by the pressing elements.

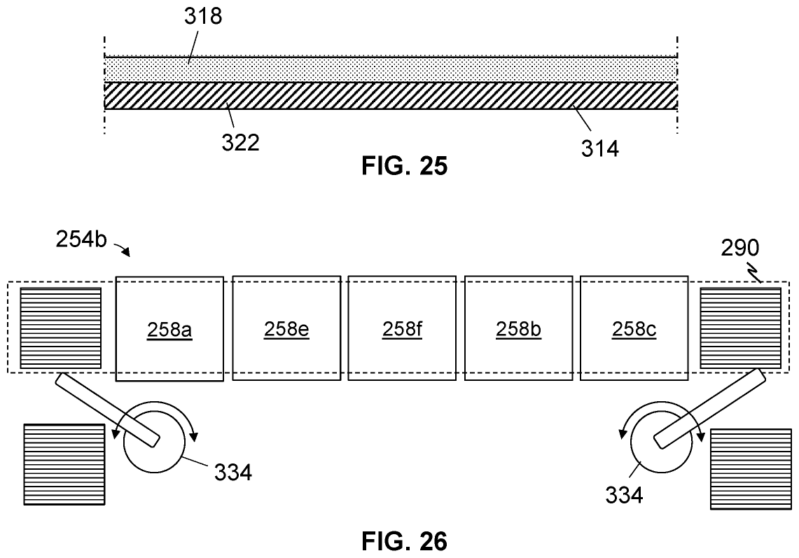

Referring additionally to FIG. 25, shown is a belt 314 that may be suitable for use in some embodiments of the present methods and/or systems (e.g., as a belt 298). Belt 314 can include a first layer 318, at least a portion of which is configured to become part of a laminate formed during consolidation of a stack of one or more laminae (e.g., 22) that is transported by the belt. For example, the stack can be in contact with first layer 318 when the stack is pressed between a set of pressing elements (e.g., 258b). First layer 318 can comprise a matrix material (e.g., 146) of the stack and/or a material having a glass transition temperature that is substantially equal to or lower than a glass transition temperature of a matrix material (e.g., 146) of the stack. Belt 314 can include a second layer 322 on which first layer 318 is disposed. Second layer 322 can comprise a resilient material, such as, for example, any one or more of the resilient materials described above.

In some instances, the pre-heating step, the consolidating step, and/or the cooling step may require different amounts of time (e.g., depending on the composition of the stack) to achieve desirable results, and the throughput of a system that performs these steps may be limited by the step that requires the longest amount of time. For example, the pre-heating step may require approximately 40 seconds for effective pre-heating, and the consolidating and cooling steps may require approximately 10 seconds for effective consolidating and cooling. If only one set of pressing elements is provided for each of these steps, the system may only be able to produce a laminate, at best, every 40 seconds.

Some methods are configured to provide for increased throughput at least by using multiple sets of pressing elements for at least one of the pre-heating step, the consolidating step, and the cooling step (e.g., for the step that requires the longest amount of time to achieve desirable results). For example, and referring additionally to FIG. 26, in some methods, the pre-heating step comprises a step 242a of pressing the stack between a heated fourth set of pressing elements 258e, and, in some instances, between a heated fifth set of pressing elements 258f. In this way, despite requiring a longer amount of time to achieve desirable results than the consolidating step and the cooling step, the pre-heating step does not unduly limit system throughput.

Some embodiments of the present methods for forming a laminate comprise: (a) pre-heating a stack of one or more laminae (e.g., 22) at least by applying a first pressure to the stack with a heated first set of pressing elements (e.g., 258a), applying a second pressure to the stack with a heated second set of pressing elements (e.g., 258e), the second pressure optionally being substantially equal to the first pressure; (b) consolidating the stack at least by applying, with a third set of pressing elements (e.g., 258b), a consolidating pressure to the stack that is greater than both the first pressure and the second pressure, at least one of the third set of pressing elements being at a consolidating temperature; and (c) cooling the stack at least by applying, with a fourth set of pressing elements (e.g., 258c), a cooling pressure to the stack that is greater than both the first pressure and the second pressure, at least one of the fourth set of pressing elements being at a cooling temperature that is lower than the consolidating temperature.

In some methods, the first pressure is between approximately 0.25 and approximately 2 bar gauge. In some methods, the consolidating pressure and/or the cooling pressure are between approximately 10 and approximately 25 bar gauge. In some methods, at least one of the first set of pressing elements is at a first temperature, at least one of the second set of pressing elements is at a second temperature, optionally, the second temperature is substantially equal to the first temperature, and optionally, the consolidating temperature is lower than both the first temperature and the second temperature.

Some embodiments of the present methods for forming a laminate comprise: (a) pre-heating a stack of one or more laminae (e.g., 22) at least by applying heat with a heat source (e.g., 258a) to the stack, the heat source being at a first temperature; (b) consolidating the stack at least by pressing the stack between a first set of pressing elements (e.g., 258b), at least one of which is at a consolidating temperature that is lower than the first temperature; and (c) cooling the stack at least by pressing the stack between a second set of pressing elements (e.g., 258c), at least one of which is at a cooling temperature that is lower than the consolidating temperature.

In some methods, pre-heating the stack comprises pressing the stack between a third set of pressing elements (e.g., 258a), at least one of which comprises the heat source. In some methods, pre-heating the stack comprises applying a first pressure to the stack with the third set of pressing elements, consolidating the stack comprises applying a consolidating pressure to the stack with the first set of pressing elements that is greater than the first pressure, and cooling the stack comprises applying a cooling pressure to the stack with the second set of pressing elements that is greater than the first pressure.

In some methods, pre-heating the stack comprises applying a second pressure to the stack with a fourth set of pressing elements (e.g., 258e), at least one of which is at a second temperature, wherein, optionally, the second pressure is substantially equal to the first pressure, and, wherein, optionally, the second temperature is substantially equal to the first temperature. In some methods, the first pressure is between approximately 0.25 and approximately 2 bar gauge. In some methods, the consolidating pressure and/or the cooling pressure are between approximately 10 and approximately 25 bar gauge.

In some methods, the first temperature is between approximately 210° C. and approximately 400° C. In some methods, the consolidating temperature is between approximately 140° C. and approximately 400° C. In some methods, the cooling temperature is between approximately 10° C. and approximately 50° C.

In some methods, at least one pressing element of at least one of the sets of pressing elements includes a resilient layer (e.g., 262) that defines at least a portion of a pressing surface (e.g., 270, 274a, 274b, and/or the like) of the pressing element. Some methods comprise disposing the stack between a bottom plate (e.g., any of plates 14a-14o, 140a-140d, or a like plate) and a top plate (e.g., any of plates 14a-14o, 140a-140d, or a like plate).

Some embodiments of the present methods comprise: disposing a stack of one or more laminae between a bottom plate (e.g., any of plates 14a-14o, 140a-140d, or a like plate) and a top plate (e.g., any of plates 14a-14o, 140a-140d, or a like plate), consolidating the stack at least by pressing the plates between a first set of pressing elements (e.g., 258b), at least one of which is at a consolidating temperature (e.g., any consolidating temperature described above), and cooling the stack at least by pressing the plates between a second set of pressing elements (e.g., 258c), at least one of which is at a cooling temperature (e.g., any cooling temperature described above) that is lower than the consolidating temperature.

In some methods, at least one of the top and bottom plates includes a layer comprising a metal (e.g., metal layer 66), and, optionally, the metal comprises steel. In some methods, at least one of the top and bottom plates comprises a resilient layer (e.g., 90), and, optionally, the resilient layer comprises polytetrafluoroethylene, silicon, and/or polyimide. In some methods, the resilient layer is a loose resilient layer and, optionally, the resilient layer is disposed on one of the top and bottom plates. In some methods, at least one of the top and bottom plates has a thickness (e.g., 130) that is less than approximately 2.0 mm.

In some methods, after cooling, the laminate formed from the stack has a thickness of less than approximately 2.0 mm.

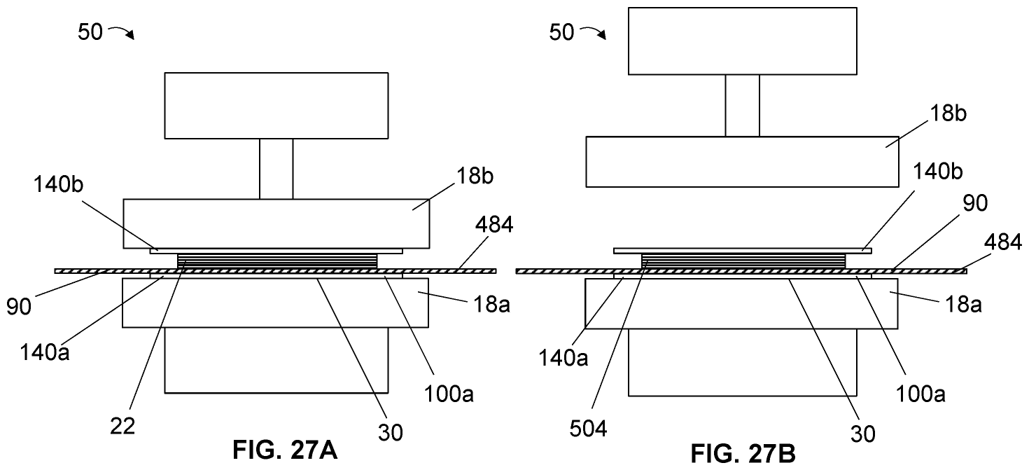

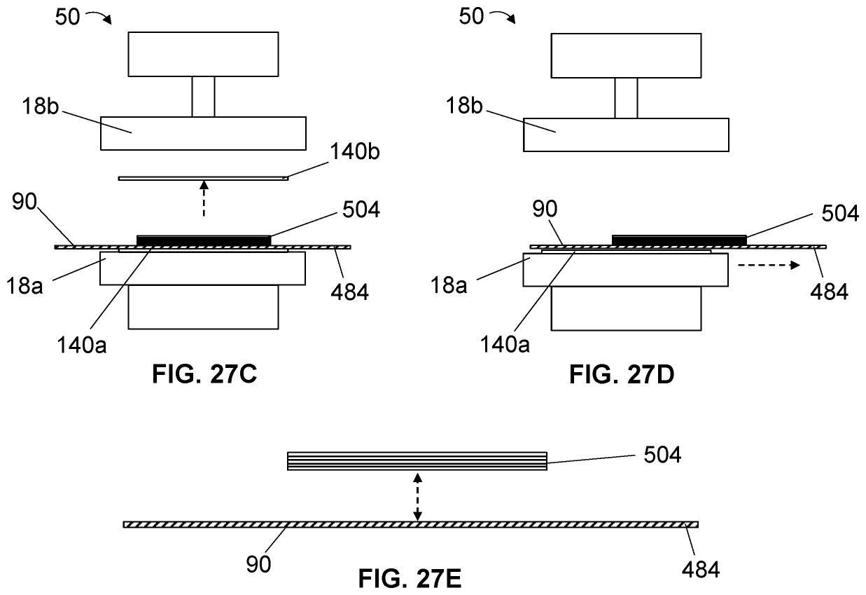

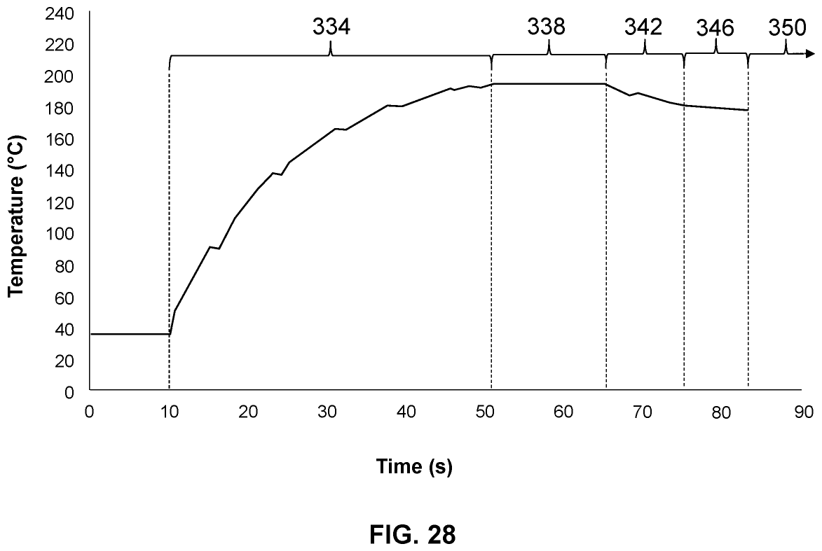

FIGS. 27A-27E provide an illustration of some embodiments of the present methods for producing one or more laminates. A system comprising press 50 and tool 100a—which includes plate 140a and plate 140b—is referenced to illustrate at least some of the following steps; however, the depicted system is not limiting on those steps, which can be performed using any suitable system (including any press and any of the tools described above).

Some embodiments of the present methods include a step of disposing top plate 140b and bottom plate 140a between pressing elements 18a and 18b of press 50. As shown, the disposing can be performed while one or more stacks of one or more laminae (e.g., 22) and a resilient layer (e.g., 90) are disposed between plates 140a and 140b. One or more portions (e.g., 484) of the resilient layer can, but need not, extend outwardly from between plates 140a and 140b.

Some embodiments of the present methods include a step of consolidating the stack(s) to form one or more laminates (e.g., 504). The consolidating can comprise pressing plates 140a and 140b between pressing surfaces 30 of pressing elements 18a and 18b. In some methods, a releasing agent can be applied to one or more surfaces of the stack(s) to, for example, discourage adhesion between the stack(s) and plates 140a and/or 140b, the resilient layer, and/or pressing elements 18a and/or 18b (if in contact with the stack(s)).

Some embodiments of the present methods include a step of removing the top plate (e.g., plate 140b) from the laminate(s). Referring now to FIGS. 27B-27C, at least one of pressing elements 18a and 18b can be moved relative to the other to permit access to the top plate. The top plate can then be removed from the laminate(s) using any suitable means (e.g., with one or more grippers). Although as depicted, the top plate is removed while tool 100a is disposed between pressing elements 18a and 18b, in some methods, the tool can be transported away from the pressing elements (e.g., with a conveyor and/or one or mero grippers) before the top plate is removed.

Via the resilient layer, removing the top plate can be performed such that the laminate(s) remain disposed on the resilient layer and the resilient layer remains disposed on the bottom plate (e.g., plate 140a). To illustrate, while the top plate is removed, the resilient layer can stabilize the laminate(s) by exerting a suction force on the laminate(s) and the bottom plate.

Some embodiments of the present methods include a step of removing the resilient layer and the laminate(s) from the bottom plate and, optionally, transporting the laminate(s) while they are disposed on the resilient layer. To illustrate, and referring to FIG. 27D, removing the resilient layer from the bottom plate (along with the laminate(s) disposed thereon) can be performed by pulling on one or more portions (e.g., 484) of the resilient layer that do not overlie the bottom plate. Some methods comprise transporting the laminate(s) on the resilient layer using, for example, a conveyor and/or one or more grippers.

Referring now to FIG. 27E, some methods include a step of removing the laminate(s) from the resilient layer. Removing the laminate(s) can comprise peeling the resilient layer from the laminate(s) by, for example, pulling the resilient layer by at least one of one or more portions of the resilient layer that do not underlie any of the laminate(s).

### EXAMPLES

The present invention will be described in greater detail by way of specific examples. The following examples are offered for illustrative purposes only and are not intended to limit the invention in any manner. Those of skill in the art will readily recognize a variety of non-critical parameters that can be changed or modified to yield essentially the same results.

### Example 1

TABLE 1 includes laminates produced using embodiments of the present methods and parameters used to produce those laminates.

TABLE 1
Laminates Produced using Embodiments of the Present Methods

| | | Temperature of | Temperature of | Temperature of |
|---|---|---|---|---|
| | | and Pressing Time | and Pressing Time | and Pressing Time |
| | | with Pre-heating | with Consolidating | with Cooling |
| Laminate | Laminate | Pressing Elements | Pressing Elements | Pressing Elements |
| Composition | Thickness | (258a) | (258b) | (258c) |
| Carbon fibers and | Up to | 240° C./40 s | 165-175° C./20 s | 25-30° C./20 s |
| polycarbonate | 2.4 mm | | | |
| matrix material | | | | |
| Carbon fibers and | Up to | 240° C./40 s | 165-175° C./10 s | 25-30° C./10 s |
| polycarbonate | 1.2 mm | | | |
| matrix material | | | | |
| Glass fibers and | Up to | None | 165-175° C./6 s | 25-30° C./6 s |
| polypropylene | 0.75 mm | | | |
| matrix material | | | | |
| Carbon fibers and | Up to | 245° C./120 s | 300° C./60 s | 25-30° C./60 s |
| polycarbonate | 1.0 mm | | | |
| matrix material | | | | |

### Example 2

A laminate was produced using an embodiment of the present methods. FIG. 22 is a graph showing stack temperature vs. time during production of the laminate. Through time period 334, the stack was pre-heated by pressing the stack between a first set of pressing elements that were at a temperature of approximately 230° C. Time period 338 is the period during which the stack was transferred to a second set of pressing elements for consolidation. During time period 342, the stack was pressed between the second set of pressing elements, which were at a temperature of approximately 170° C. The stack was transferred to a third set of pressing elements for cooling during time period 346. Through time period 350, the stack was pressed between the third set of pressing elements, which were at room temperature.

### Example 3

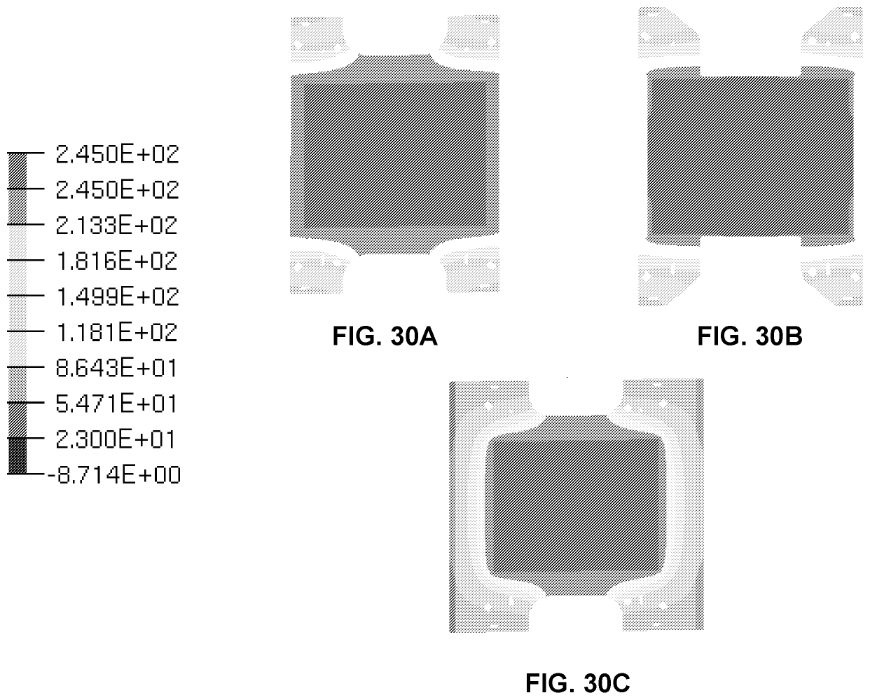

Simulations were performed for each of: (1) a “flat plate” (FIG. 30A); (2) plate 140a (FIG. 30B); and (3) a plate having bent edges (a “bent plate”) (FIG. 30C) to compare the thermal and mechanical responses of the plates when used to form a laminate. Each of the plates included a center region having first and second widthwise edges, two tabs extending from the first widthwise edge, and two tabs extending from the second widthwise edge. And, the plates were similarly sized in that, if a first one of any of the plates was disposed on top of a second one of any other of the plates, each of the openings of the tabs of the first plate could be simultaneously aligned with each of the openings of the tabs of the second plate. Further, each of the plates comprised SAE 304 stainless steel. The primary differences between the plates are described below.

For plate 140a, the size of the center region closely matched that of heating plate 508 (described below). On the other hand, the size of the center region of each of the flat plate and the bent plate was appreciably larger than that of heating plate 508. With a smaller center region, the widthwise distance between the outermost edges of the tabs was larger than the width of the center region for plate 140a, whereas, for each of the flat plate and the bent plate, the widthwise distance between the outermost edges of the tabs was equal to the width of the center region.

Plate 140a and the flat plate were both flat, but the lengthwise edges of the bent plate were bent to define flanges that extended along its center region and tabs. Finally, plate 140a and the flat plate each had a thickness of 1 mm, whereas the bent plate had a thickness of 0.5 mm.

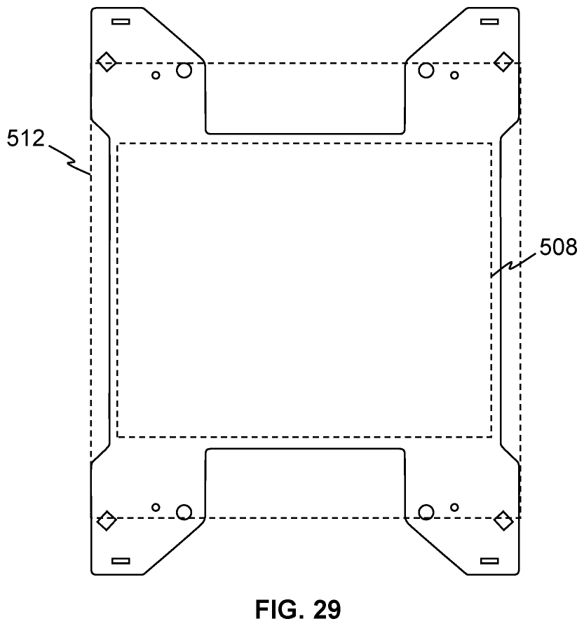

FIG. 29 illustrates the boundary conditions for each of the simulations. While the boundary conditions are depicted for plate 140a, the same boundary conditions were used for the flat plate and the bent plate. A heating plate 508—having a constant temperature of 245° C.—contacted and transferred heat to the tool plate. For an isolated region 512 around heating plate 508, heat could neither be added to nor lost from the tool plate. Outside of isolated region 512, including portions of the tabs, convective and radiative heat transfer were permitted.

Where the tool plate contacted heating plate 508 as well as in isolated region 512, out-of-plane displacement of the tool plate was prevented (e.g., modelling the presence of the press and laminate), and outside of isolated region 512, in-plane and out-of-plane displacements of the plate were allowed.

For each of the plates, steady state solutions were calculated for each of three different conditions, as set forth in TABLE 2.

TABLE 2
Ambient Conditions

| | | Convective Heat |
|---|---|---|
| | Ambient | Transfer |
| Condition | Temperature | Coefficient |
| # | (° C.) | (W/m²K) |
| 1 | 50 | 1 |
| 2 | 23 | 1 |
| 3 | 23 | 7 |

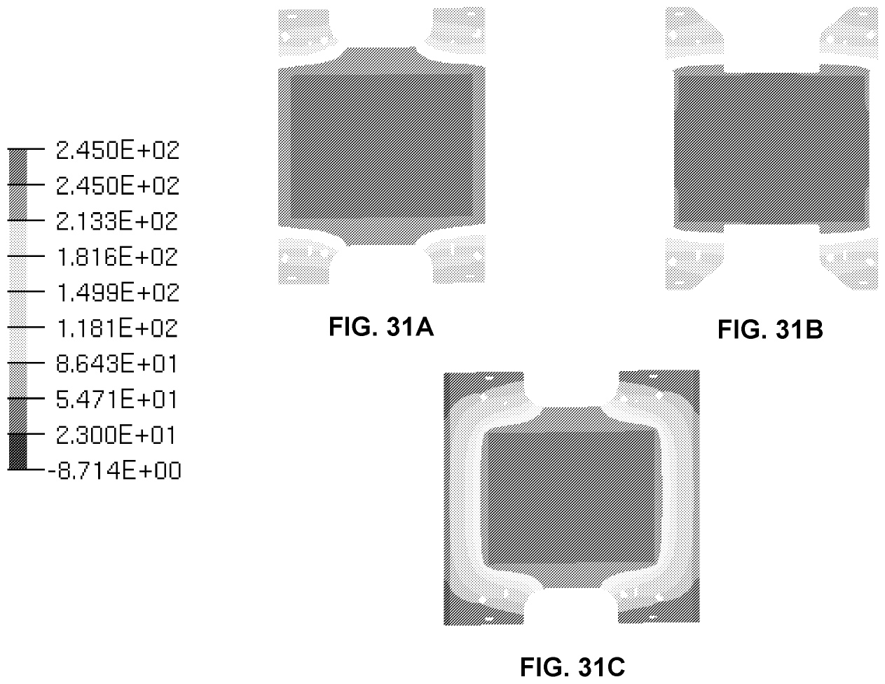

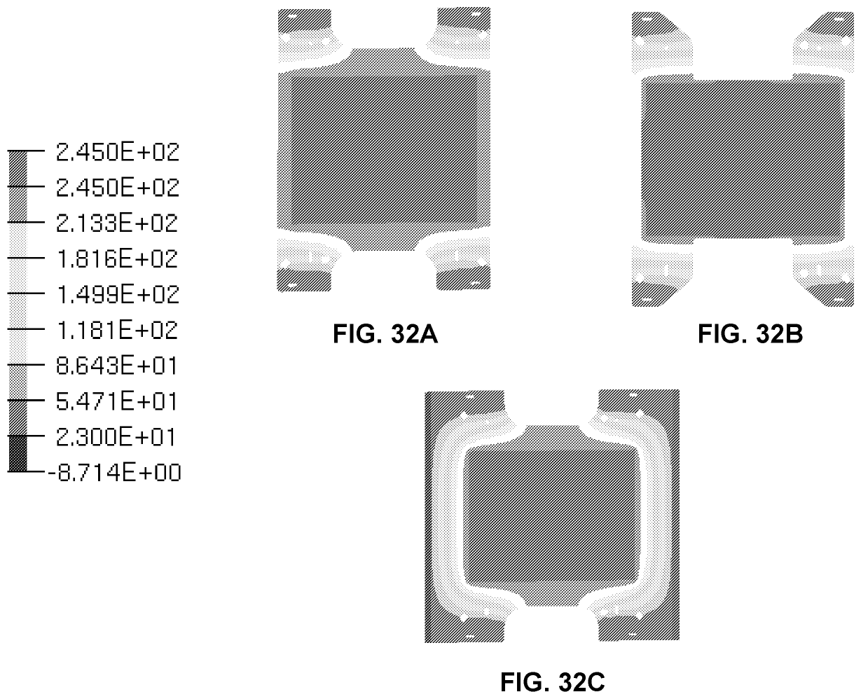

The thermal response of each of the plates is depicted: (1) for condition 1, in FIGS. 30A-30C; (2) for condition 2, in FIGS. 31A-31C; and (3) for condition 3, in FIGS. 32A-32C. In each of these figures, the temperature scale is in ° C. For each of the conditions, plate 140a had a more uniform temperature distribution in its center region than did either of the flat and bent plates in its center region. This is due to the center region of plate 140a having a size that more closely matched that of heating plate 508. Also driven by the size of its center region, the temperature gradients in plate 140a were more aligned with the length of the plate than were those of the flat and bent plates, each of which had temperature gradients in its larger center region that pointed inwardly—in both lengthwise and widthwise directions. Due to these differences in temperature gradients, in areas where the tabs extend from the center region, temperatures were lower for the flat and bent plates than for plate 140a.

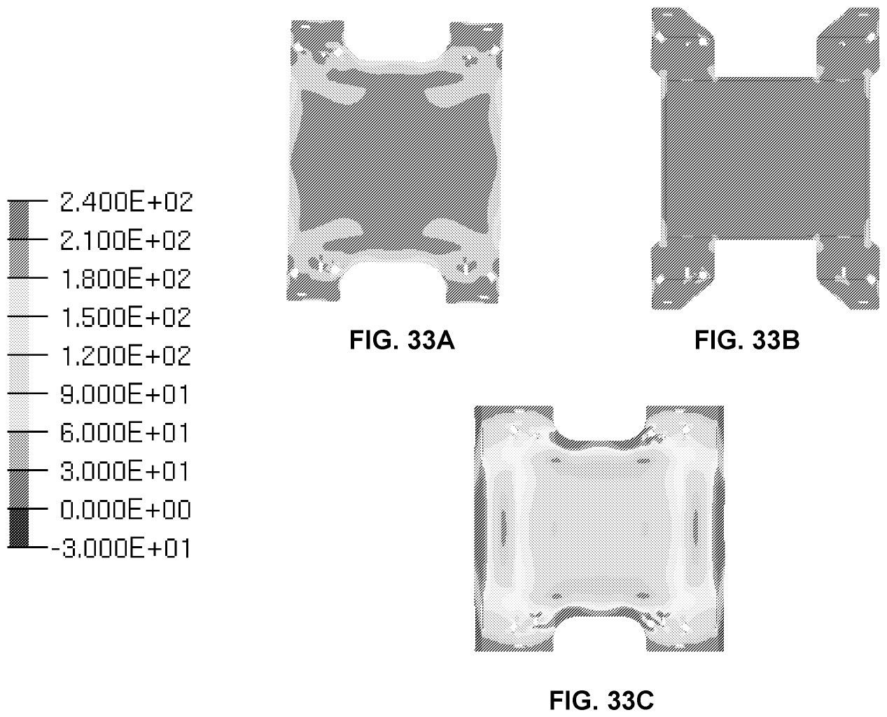

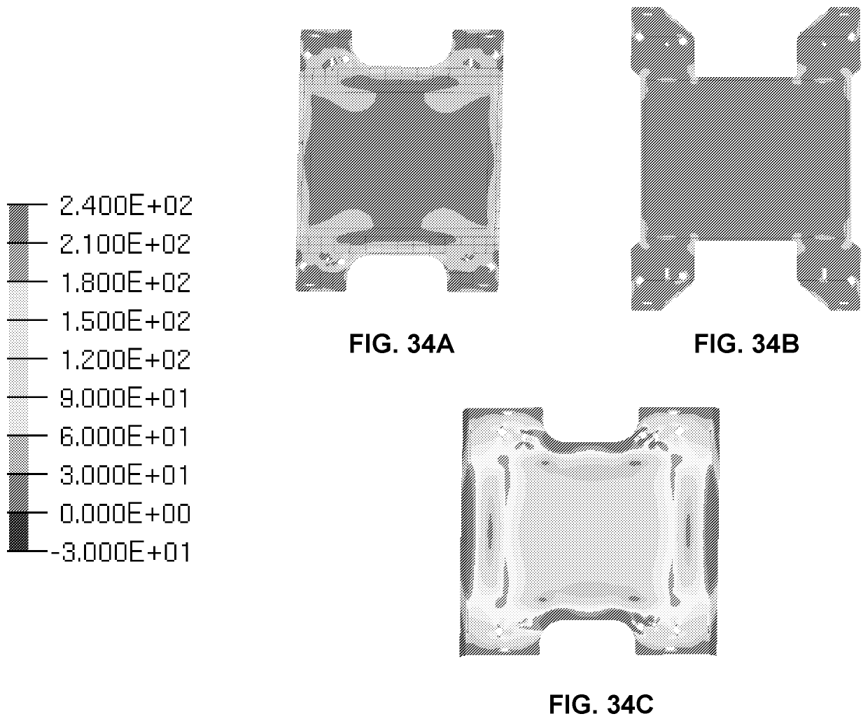

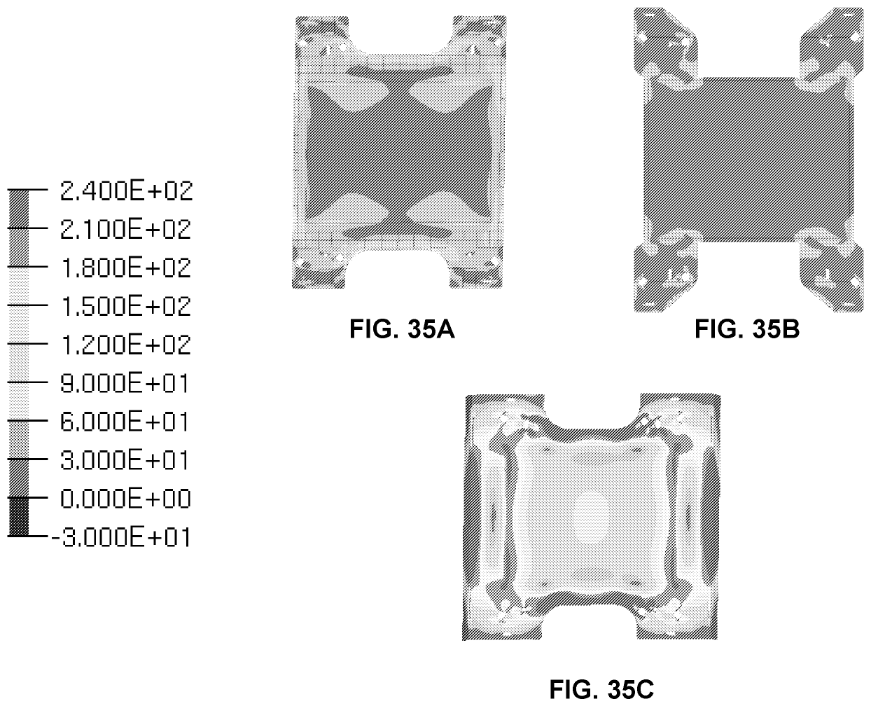

The mechanical response of each of the plates is depicted: (1) for condition 1, in FIGS. 33A-33C; (2) for condition 2, in FIGS. 34A-34C; and (3) for condition 3, in FIGS. 35A-35C. For each of these figures, the scale is in megapascals (MPa). As shown, the center regions of the flat and bent plates had larger stress concentrations—in both size and magnitude—than the center region of plate 140a.

TABLE 3 provides the maximum stress for each plate in each condition.

TABLE 3
Maximum Stresses (von Mises)

| | Plate 140a | Flat Plate | Bent Plate |
|---|---|---|---|
| Condition # | (MPa) | (MPa) | (MPa) |
| 1 | 152 | 162 | 324 |
| 2 | 160 | 178 | 332 |
| 3 | 207 | 231 | 342 |

As indicated, stresses in plate 140a were lower than in either of the flat and bent plates. This may be due to the flat and bent plates each having a larger center region across which the temperature of the plate changed and that was relatively constrained from displacement by the plate's geometry and the press. On the other hand, in plate 140a, the temperature changes were concentrated in the tabs that, by extending outwardly from the plate and outside of the press, were relatively unconstrained from displacement.

### Example 4

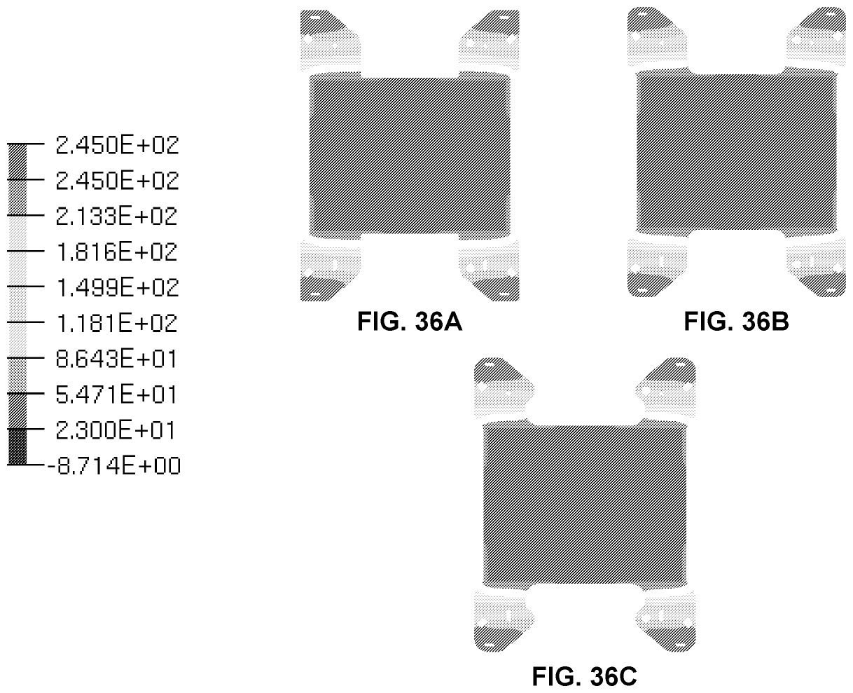

The simulations in Example 3 were repeated for plate 140c (FIG. 36B) and plate 140d (FIG. 36C) under condition 3 (TABLE 2), and these results were compared to those above for plate 140a under condition 3 (FIG. 36A, which is the same as FIG. 32B). Like plate 140a, plates 140c and 140d each comprised SAE 304 stainless steel and had a thickness of 1 mm.

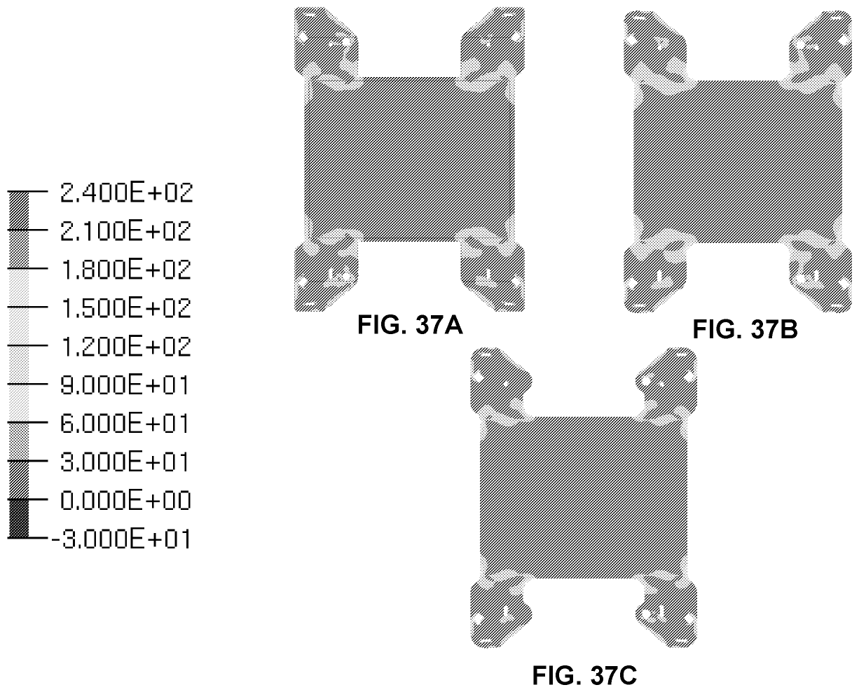

FIGS. 36A-36C depict the thermal response of each of the plates, and FIGS. 37A-37C depict the mechanical response of each of the plates. Starting with the thermal responses, the temperature distributions in the plates were similar, each being generally uniform throughout the center region with temperature changes concentrated in the tabs. Correspondingly, the mechanical responses of the plates were also similar. However, stress concentrations were smaller in magnitude for plates 140c and 140d than for plate 140a, which may be due to plates 140c and 140d each having corners of larger radii than those of plate 140a. These smaller stresses are evidenced in TABLE 4, which includes the maximum stress for each of the plates.

TABLE 4
Maximum Stresses (von Mises)

| | Maximum Stress |
|---|---|
| Plate | (MPa) |
| 140a | 207 |
| 140c | 175 |
| 140d | 153 |

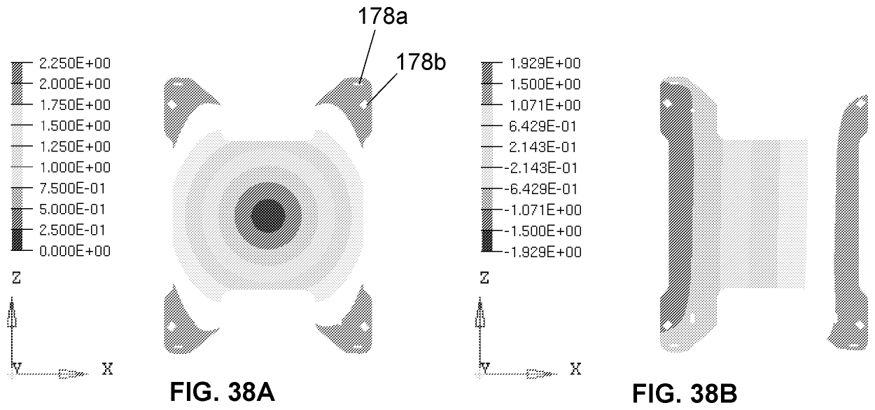

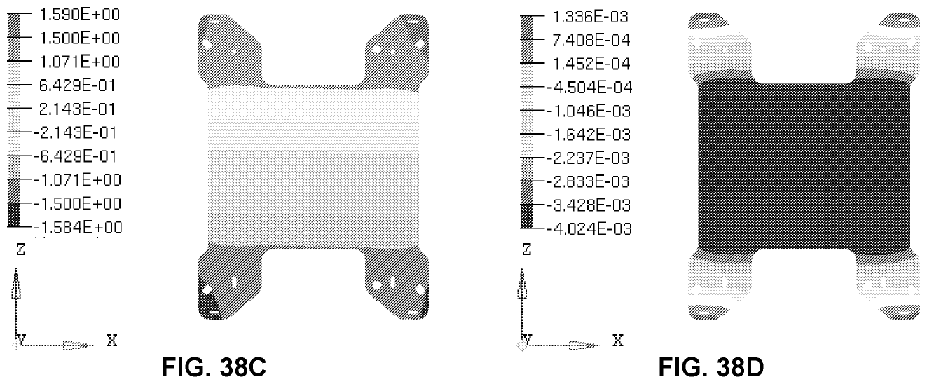

Displacements of plate 140c were also calculated. These displacements are shown in FIGS. 38A-38D: (1) FIG. 38A depicts total displacements; (2) FIG. 38B depicts displacements in the x-direction; (3) FIG. 38C depicts displacements in the z-direction; and (4) FIG. 38D depicts displacements in the y-direction. For each of these figures, the x-, z-, and y-directions are as indicated in the figure, and the scale is in mm. While x- and z-displacements were on the order of mm, y-displacements were on the order of micrometers (μm) or smaller. Thus, out-of-plane displacements for plate 140c were minimal; this is advantageous, at least because such out-of-plane displacements could cause out-of-plane deformations of a laminate formed using the plate.

The x-, z-, and y-displacements at opening 178a and at opening 178b (labeled in FIG. 38A) are included in TABLE 5.

TABLE 5
Displacements at Openings 178a and 178b

| | x-displacement | z-displacement | y-displacement |
|---|---|---|---|
| Location | (mm) | (mm) | (μm) |
| Opening 178a | 1.0 | 1.5 | 0.5 |
| Opening 178b | 1.1 | 1.5 | −0.4 |

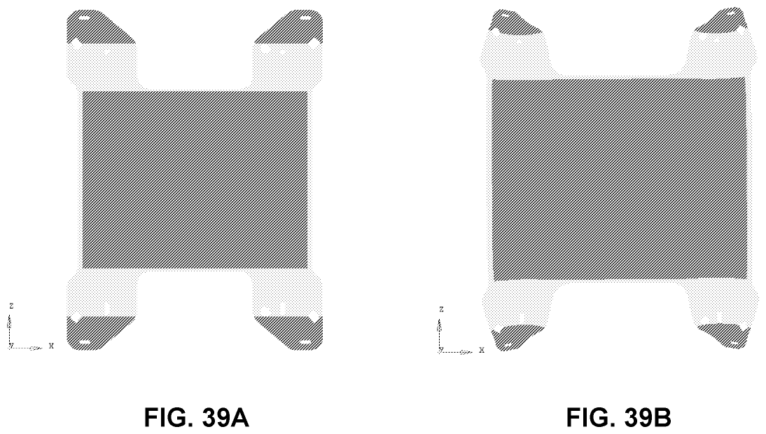

Provided by way of illustration, FIG. 39A shows plate 140c in an undisplaced state, and FIG. 39B shows the plate in an exaggerated displaced state, in which the displacements are scaled up by a factor of 200. The outer portions of the tabs, being cooler than the inner portions of the tabs and the center region, experienced smaller displacements than did the inner portions of the tabs and the center region.

### Example 5

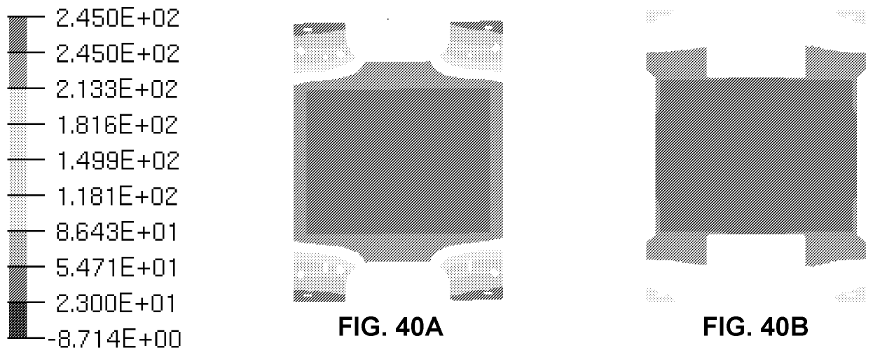

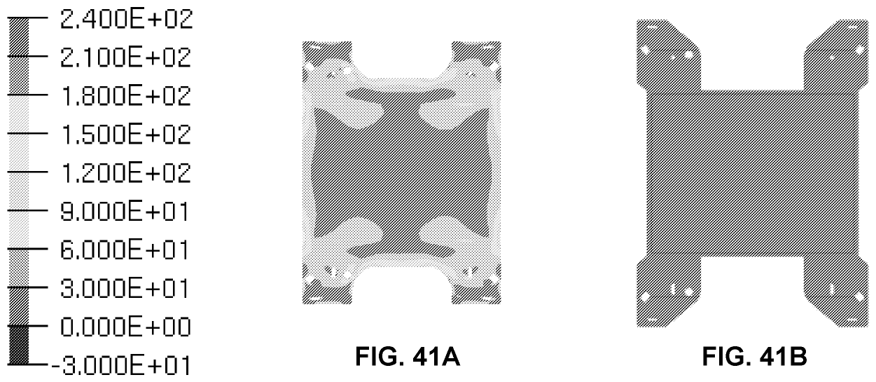

To study the effect of thickness and material on plate performance, the simulations in Example 3 using condition 3 (TABLE 2) were repeated for: (1) a flat plate that was otherwise similar to that of Example 3, but had a thickness of 2 mm; and (2) plate 140a comprising aluminum, rather than SAE 304 stainless steel. FIGS. 40A and 40B depict the thermal responses of these plates (temperatures in ° C.), and FIGS. 41A and 41B depict the mechanical responses of these plates (stresses in MPa).

Increasing plate thickness was shown to promote uniformity of temperature distribution. To illustrate, for the thicker flat plate (FIG. 40A), the tabs were, on average, hotter—closer to the temperature of the portion of the tool plate in contact with heating plate 508—than for the thinner flat plate (FIG. 32A). Corresponding reductions in plate stresses were also seen (compare FIG. 41A for the thicker flat plate with FIG. 35A for the thinner flat plate). The maximum stresses in the thicker and thinner flat plates are included in TABLE 6.

TABLE 6
Maximum Stresses (von Mises)

| | Maximum Stress |
|---|---|
| Plate | (MPa) |
| Thicker Flat Plate | 202 |
| Thinner Flat Plate | 231 |

Turning to the effect of material on plate performance, substantial increases in temperature distribution uniformity (compare FIG. 40B with FIG. 32B) along with substantial decreases in plate stresses (compare FIG. 41B with FIG. 35B) were seen when plate 140a's SAE 304 stainless steel was replaced with aluminum. To illustrate, the maximum stresses in the aluminum plate 140a and in the SAE 304 stainless steel plate 140a are provided in TABLE 7.

TABLE 7
Maximum Stresses (von Mises)

| | Maximum Stress |
|---|---|
| Plate | (MPa) |
| Aluminum Plate 140a | 20 |
| SAE 304 Stainless Steel Plate 140a | 207 |

### Example 6

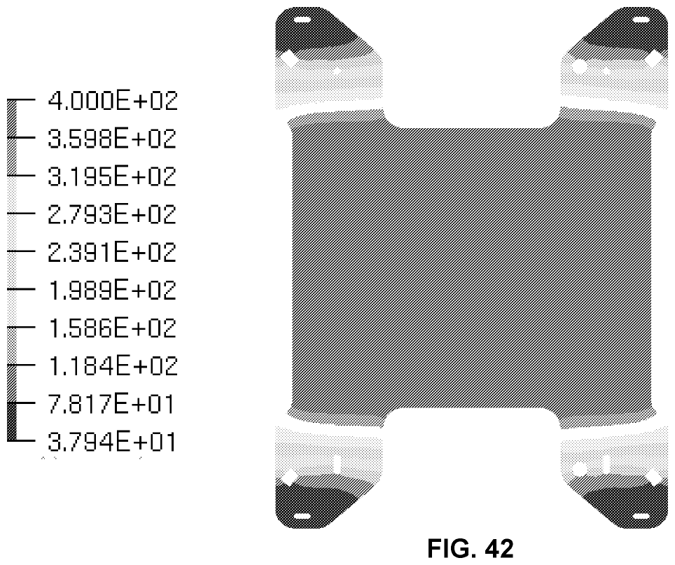

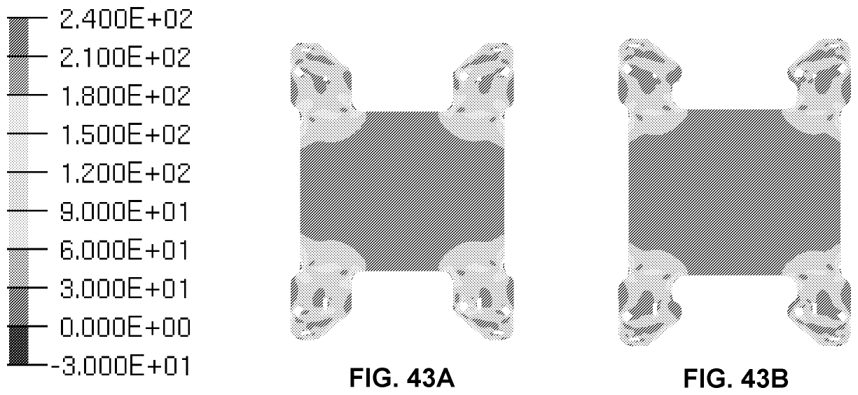

The simulations in Example 3 were repeated for plate 140c and plate 140d under condition 3, except that heating plate 508 had a constant temperature of 400° C. instead of 245° C. FIG. 42 depicts the thermal response for plate 140c, with temperatures in ° C., and FIGS. 43A and 43B depict the mechanical responses of plates 140c and 140d, respectively, with stresses in MPa. As expected, the increased temperature of heating plate 508 resulted in larger temperature changes and stresses in both plates. Indicated in red in FIGS. 43A and 43B, each of the plates exceeded its yield stress (assumed to be 240 MPa for SAE 304 stainless steel) where its tabs connect to its center region. The maximum stresses in the two plates are included in TABLE 8.

TABLE 8
Maximum Stresses (von Mises)

| | Maximum Stress |
|---|---|
| Plate | (MPa) |
| 140c | 253 |
| 140d | 244 |

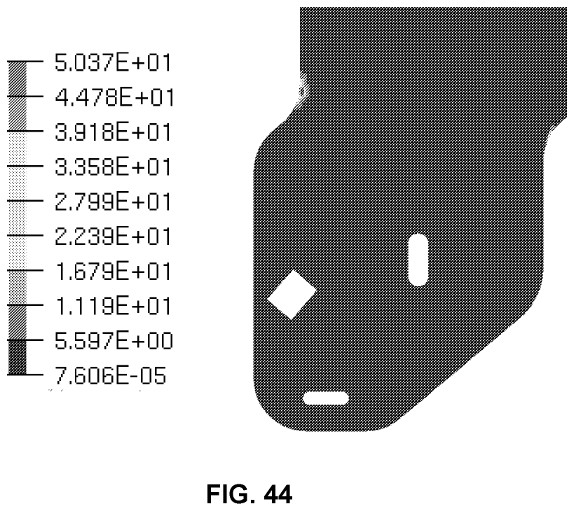

It was also determined that plate 140c, if allowed to cool to room temperature, would have 50 MPa of residual stress (depicted in FIG. 44).

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method for producing one or more laminates, the method comprising:
disposing one or more stacks of one or more laminae between top and bottom plates of a tool and on a resilient layer that is disposed on the bottom plate, the disposing such that, for each of the stack(s):
each of the plates underlies or overlies all of the stack; and
the resilient layer underlies all of the stack;
consolidating the stack(s) to produce one or more laminates at least by pressing the plates between pressing surfaces of a press; and
removing the laminate(s) from between the plates at least by:
(a) removing the top plate from the laminate(s) without removing the laminate(s) from the resilient layer or the resilient layer from the bottom plate; and
(b) removing the resilient layer from the bottom plate without removing the laminate(s) from the resilient layer.

2. The method of claim 1, wherein:
after disposing the stack(s), one or more portions of the resilient layer do not overlie the bottom plate; and
removing the resilient layer from the bottom plate comprises pulling the resilient layer by at least one of the resilient layer portion(s).

3. The method of claim 1 or 2, wherein:
each of the plates includes:
a center region; and
tabs that extend outwardly from edges of the center region;
after disposing the stack(s), for each of the plates, at least a portion of each of the tabs neither overlies nor underlies the resilient layer; and
the method comprises transporting the stack(s) using a conveyor or one or more grippers coupled to at least one of the tab portions.

4. The method of claim 3, wherein:
the center region is rectangular and has:
a length;
a width; and
first and second widthwise edges;
two of the tabs extend outwardly from the first widthwise edge, and two of the tabs extend outwardly from the second widthwise edge;
for ones of the tabs that extend from a same one of the widthwise edges, a distance, measured parallel to the width of the center region, between outermost edges of the tabs is at least 5% larger than the width of the center region; and
for ones of the tabs that extend from different ones of the widthwise edges, a distance, measured parallel to the length of the center region, between outermost edges of the tabs is at least 20% larger than the length of the center region.

5. The method of any of claims 1-4, comprising peeling the resilient layer from the laminate(s).

6. The method of claim 5, wherein:
after disposing the stack(s), one or more portions of a periphery of the resilient layer do not underlie any of the stack(s); and
peeling the resilient layer comprises pulling the resilient layer by at least one of the resilient layer portion(s).

7. The method of any of claims 1-6, wherein the resilient layer comprises polytetrafluoroethylene, silicon, and/or polyimide.

8. The method of any of claims 1-7, wherein the resilient layer has a thickness that is less than approximately 3.0 millimeters (mm).

9. The method of any of claims 1-8, wherein each of the plates has a thickness that is less than approximately 2.0 mm.

10. The method of any of claims 1-9, wherein each of the laminate(s) has a thickness that is less than approximately 2.0 mm.

11. A system for pressing one or more stacks of one or more laminae, the system comprising:
a tool including top and bottom plates configured to be disposed on opposing sides of each of one or more stacks of one or more laminae, each of the plates having:
a center region that overlies or underlies the stack(s) when the stack(s) are disposed between the plates; and
tabs that extend outwardly from edges of the center region and are configured to be coupled to a conveyor or one or more grippers for moving the plate; and
a resilient layer configured to be disposed between the top plate and the stack(s) or the bottom plate and the stack(s);
wherein the resilient layer is sized to be disposable between the plates such that, for each of the plates:
the resilient layer overlies or underlies at least 90% of the center region;
one or more portions of the resilient layer neither overlie nor underlie the plate; and
at least a portion of each of the tabs neither overlies nor underlies the resilient layer.

12. The system of claim 11, wherein, for each of the plates, the center region is rectangular and has:
a length;
a width; and
first and second widthwise edges.

13. The system of claim 12, wherein the resilient layer has:
a width that is at least 5% larger than the width of the center region of each of the plates; and/or
a length that is at least 5% larger than the length of the center region of each of the plates.

14. The system of claim 12 or 13, wherein, for each of the plates:
two of the tabs extend outwardly from the first widthwise edge, and two of the tabs extend outwardly from the second widthwise edge;
for ones of the tabs that extend from a same one of the widthwise edges, a distance, measured parallel to the width of the center region, between outermost edges of the tabs is at least 5% larger than the width of the center region; and
for ones of the tabs that extend from different ones of the widthwise edges, a distance, measured parallel to the length of the center region, between outermost edges of the tabs is at least 20% larger than the length of the center region.

15. The system of any of claims 11-14, wherein the resilient layer comprises polytetrafluoroethylene, silicon, and/or polyimide.
